(19) United States
(12) Patent Application Publication
(10) Pub. No.: US 2024/0380483 A1
(43) Pub. Date: Nov. 14, 2024

(54) DEEP LEARNING METHODS AND SYSTEMS FOR DETECTION OF PULSE SIGNALS

(71) Applicant: THE UNITED STATES OF AMERICA, AS REPRESENTED BY THE SECRETARY OF THE NAVY, Arlington, VA (US)

(72) Inventors: Daniel Stephen Green, Spanish Fort, AL (US); Murali Tummala, Monterey, CA (US); John McEachen, Carmel, CA (US)

(21) Appl. No.: 18/583,509

(22) Filed: Feb. 21, 2024

Related U.S. Application Data
(60) Provisional application No. 63/447,280, filed on Feb. 21, 2023.

(51) Int. Cl. H04B 10/077; H04L 25/02; H04L 25/49; H04L 27/00

(52) U.S. Cl. CPC H04B 10/0775; H04L 25/0254; H04L 25/4902; H04L 27/0004

(57) ABSTRACT

A method and system for detecting pulsed communication signals, the method and system includes obtaining a time-frequency representation of a received training data signal, the received training data signal representative of a known/training bitstream associated with a transmitted pulse signal; using a scalogram process to convert the time-frequency representation of the received training data signal into a plurality of training images, and training a deep learning architecture platform with the plurality of training images to generate a classification model representative of a plurality of high bit states and a plurality of low bit states included in the plurality of training images. The disclosed method and system uses the CWT process to obtain a time-frequency representation of a target data signal, and uses the scalogram process to convert the time-frequency representation of the received target data signal into a plurality of respective target images representative of each of the bit states in the incoming target data signal bitstream; and using the trained deep learning architecture platform, classifies each of the plurality of respective target images as one of a high bit state and a low bit state; and generates an output bitstream based on the plurality of respective target images associated with the incoming data signal, wherein the incoming target data signal is one or both of turbo encoded and multipulse pulse position modulation (MPPM) encoded.

### CROSS REFERENCE TO RELATED PATENT(S) AND APPLICATION(S)

This application claims the benefit of U.S. Provisional Application No. 63/447,280 filed Feb. 21, 2023, and entitled DETECTION OF VISIBLE LIGHT PULSE SIGNALS USING A DEEP LEARNING APPROACH, which is hereby incorporated in its entirety by reference.

### BACKGROUND

This disclosure, and the exemplary embodiments described herein, describe deep learning methods and systems for detection of pulse communication signals, particularly in noisy environments, however it is to be understood that the scope of this disclosure is not limited to such application.

In September 2017, Microsoft Corporation aired a television commercial promoting Microsoft Artificial Intelligence (AI). The commercial began with a captive statement: “With AI, we can protect what we can't see.” The Snow Leopard Trust, a nonprofit organization focused on protecting the endangered snow leopard, detailed their use of Microsoft's Artificial Intelligence (AI) to scan pictures from remote cameras in the mountains to identify the elusive snow leopard. They claimed that utilizing Microsoft AI, the ten-day task now takes only ten minutes [Ref. 1].

The use of AI to quickly process large amounts of data holds promise for many other applications, including pulsed communications.

### INCORPORATION BY REFERENCE

The following publications are incorporated by reference in their entirety.
S. Koss, “Symbol generation and frame synchronization for multipulse pulse position modulation,” M.S. thesis Dept of Electrical and Computer Engineering, NPS, Monterey, CA, USA, 2020.
S. Koss, C. McAbee, M. Tummala and J. McEachen, “Symbol generation and frame synchronization for multipulse-pulse position modulation over optical channels,” 14th International Conference on Signal Processing and Communication, December 2020.
D. Green, M. Tummala and J. McEachen, “Pulsed Signal Detection Utilizing Wavelet Analysis with a Deep Learning Approach,” MILCOM 2021-2021 IEEE Military Communications Conference (MILCOM), San Diego, CA, USA, 2021, pp. 396-401.
US Published Patent Application 2022/0131614, by Shawn Christian Koss, et al., published Apr. 28, 2022, and entitled Symbol Generation and Frame Synchronization for Multipulse-Pulse Position Modulation, now U.S. Pat. No. 11,683,100.

### BRIEF DESCRIPTION

In accordance with one exemplary embodiment of the present disclosure, disclosed is a method for detecting pulsed communication signals, the method comprising: processing a received training data signal, which includes a noise element, with a continuous wavelet transformation (CWT) process to obtain a time-frequency representation of the received training data signal, the received training data signal representative of a known/training bitstream associated with a transmitted pulse signal; using a scalogram process to convert the time-frequency representation of the received training data signal into a plurality of training images, each training image associated with a single bit of information which includes either a high bit state or a low bit state; training a deep learning architecture platform with the plurality of training images to generate a classification model representative of a plurality of high bit states and a plurality of low bit states included in the plurality of training images; receiving an incoming target data signal, the incoming signal including a data bitstream represented as a series of pulses and the incoming signal also including one or more noise elements, using the CWT process to obtain a time-frequency representation of the received incoming data signal, and using the scalogram process to convert the time-frequency representation of the received incoming target data signal into a plurality of respective target images representative of each of the bit states in the incoming target data signal bitstream; and using the trained deep learning architecture platform, classifying each of the plurality of respective target images as one of a high bit state and a low bit state; and generating an output bitstream based on the plurality of respective target images associated with the incoming data signal, wherein the incoming target data signal is one or both of turbo encoded and multipulse pulse position modulation (MPPM) encoded.

In accordance with another exemplary embodiment of the present disclosure, disclosed is a method for decoding multipulse pulse position modulation (MPPM) symbols included in a received data signal, the method comprising: receiving an incoming target data signal, the incoming signal including a data bitstream represented as a series of pulses based on an MPPM symbol representative of a series of time slots where a pulse may or may not occur, and the incoming target data signal also including one or more noise elements, using the continuous wavelet transformation (CWT) process to obtain a time-frequency representation of the received incoming data signal; using a scalogram process to convert the time-frequency representation of the received training data signal into a plurality of training images, each training image associated with a single bit of information which includes either a high bit state or a low bit state; and using a trained deep learning architecture platform to assign probabilities in a decision matrix, the probabilities associated with the likelihood that a 1 or 0 bit was transmitted for specific time slots associated with the MPPM symbol, determining a location of the highest probability that a 1 bit (high) was received; comparing the location of a received bit with the highest probability to possible sequences to identify a matching bit sequence associated with a predetermined set of possible bit sequences to identify a matching bit sequence; and decoding the symbol based on the matching bit sequence.

In accordance with another exemplary embodiment of the present disclosure, disclosed is a system for detecting pulsed communication signals, the system comprising: a data signal receiver processing a received training data signal, which includes a noise element, with a continuous wavelet transformation (CWT) process to obtain a time-frequency representation of the received training data signal, the received training data signal representative of a known/training bitstream associated with a transmitted pulse signal; a scalogram module converting the time-frequency representation of the received training data signal into a plurality of training images, each training image associated with a single bit of information which includes either a high bit state or a low bit state; a deep learning architecture platform operatively associated with the scalogram module, training the deep learning architecture platform with the plurality of training images to generate a classification model representative of a plurality of high bit states and a plurality of low bit states included in the plurality of training images; and the system for detecting pulse signals performing the method comprising: receiving an incoming target data signal, the incoming signal including a data bitstream represented as a series of pulses and the incoming signal also including one or more noise elements, using the CWT process to obtain a time-frequency representation of the received incoming data signal, and using the scalogram process to convert the time-frequency representation of the received incoming target data signal into a plurality of respective target images representative of each of the bit states in the incoming target data signal bitstream; using the trained deep learning architecture platform, classifying each of the plurality of respective target images as one of a high bit state and a low bit state, and generating an output bitstream based on the plurality of respective target images associated with the incoming data signal, wherein the incoming target data signal is one or both of turbo encoded and multipulse pulse position modulation (MPPM) encoded.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a more complete understanding of the present disclosure, reference is now made to the following descriptions taken in conjunction with the accompanying drawings.

FIG. 1 is an OOK waveform in which a pulse corresponds to transmitting a one bit and the absence of a pulse corresponds to transmitting a zero bit. Adapted From: [Ref. 14].

FIG. 2 is a pulse modulation waveform with original signal (A), sample time (B), and two modulation techniques (C-D). PWM (C) alters the pulse width to transmit symbols. PPM (D) alters the timing location of the pulse to transmit symbols. Source: [Ref. 10].

FIG. 3 is an example MPPM alphabet for Q=4, p=2. Source: [Ref. 18], [Ref. 11].

FIG. 4 is a rate R=½ convolutional encoder with memory order m=3.

FIG. 5 is a turbo encoder structure with two recursive systematic convolutional (RSC) encoders.

FIGS. 6A-6C show continuous wavelet transform shape dilated by α and translated by β Time-widths vary based on the varying frequency of the individual wavelet function. Adapted from: [Ref. 25].

FIG. 7A-7F show Wavelet transformation functions: (A) biorthogonal 1.3, (B) biorthogonal 2.4, (C) symlet 4, (D) Ricker, (E) Morlet, and (F) Haar.

FIGS. 8A and 8B shows a simple neural network with k inputs, a single node, and a single output (A) and Deep neural network with k inputs, a single output, and l hidden layers (B).

FIGS. 9A and 9B show (9A) convolutional layer weights for GOOGLENET CNN and (9B) example activation using channel 53 from FIG. 9A showing the strongest features of the input image. Source: [Ref. 29].

FIG. 10 shows a disclosed methodology of a deep learning approach for classifying information over a noisy channel.

FIG. 11 shows a time amplitude representation of a received signal.

FIGS. 12A and 12B show CWT decomposition by frequency scale: (A) time amplitude representation with incorrectly classified bit 88; and (B) scalogram representation of signal following CWT in which bit 88 only produces large coefficients at high frequencies.

FIG. 13 shows scalogram of CWT coefficient absolute values from biorthogonal 1.3 wavelet analysis.

FIGS. 14A and 14B show a biorthogonal wavelet: (A) wavelet function positioned before pulse signal. The convolution operation yields a large negative coefficient value; (B) wavelet function positioned at same time as pulse signal. The convolution operation yields a large positive coefficient value.

FIG. 15 shows scalogram of positive CWT coefficient values from biorthogonal 1.3 wavelet analysis.

FIG. 16 shows a reconstructed CWT corresponding to a bit one transmitted.

FIG. 17 shows GOOGLENET Inception sublayer. Adapted from: [Ref. 30].

FIGS. 18A-C show a multidomain representation of an experimental signal: (A) time amplitude domain representation of the received signal; (B) scalogram of CWT coefficient values from biorthogonal 1.3 wavelet analysis; and (C) bitstream ground truth.

FIG. 19 shows an image capture for bit position 83 of the eighth transmission with an interference pulse.

FIG. 20 shows BER versus image capture window size for a single transmitter.

FIG. 21 shows BER versus window size for multiple transmitter propagation.

FIGS. 22A-C shows CNN training comparisons: (A) training progress for dataset with interference pulses with rate of arrival λ, and (B) training progress for dataset with no interference pulses.

FIG. 23 shows Rate R=½ convolutional encoder.

FIG. 24 shows turbo encoder using a parallel concatenated convolutional encoding scheme with rate R=½ RSC encoders.

FIG. 25 shows a disclosed MPPM scheme with turbo coding for optical transmission over a noisy communication channel. Modified from: [Ref. 11].

FIGS. 26A and 26B shows Image captures for an MPPM transmission from alphabet in Table 7. (A) Pulse located in the eighth time slot indicating that z₄ is the transmitted symbol. (B) Pulse located in the ninth time slot indicating that z₆ is the transmitted symbol.

FIGS. 27A and 27B shows 100 time slots with interference arrival rate 32λ: (A) transmit pulses, (B) interference pulses.

FIG. 28 shows BER comparison between MPPM schemes with varying bits/symbol.

FIG. 29 shows BER comparison between coherent OOK matched filter detection, and a deep learning approach with MPPM (24, 3) scheme and FEC coding.

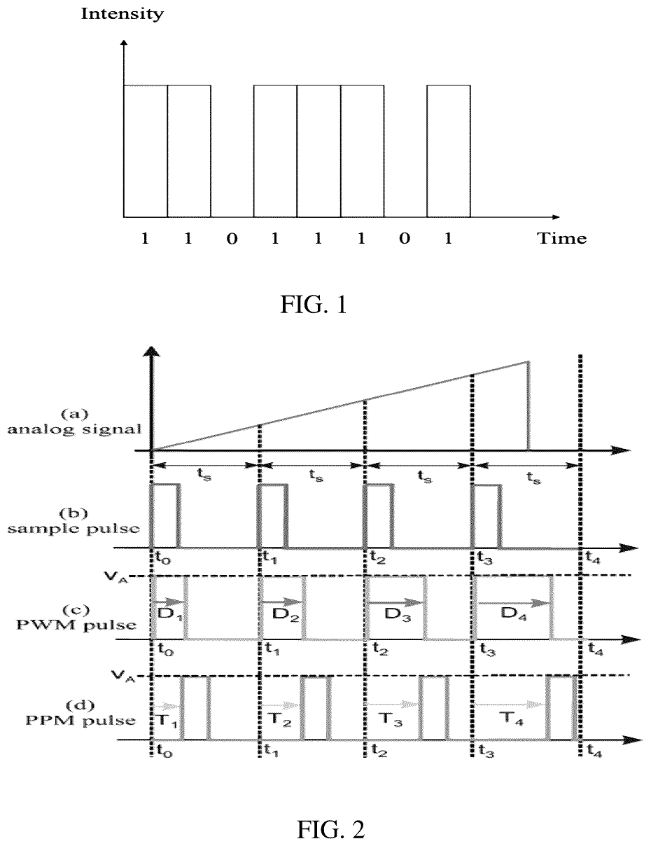

### DETAILED DESCRIPTION

This disclosure and exemplary embodiments described herein provide deep learning methods and systems for detection of pulse communication signals, particularly in noisy communication environments, however it is to be understood that the scope of this disclosure is not limited to such application. For instance, according to an example embodiment, a method and system of detecting visible light pulse signals is disclosed.

Pulsed transmission techniques in noisy channels result in pulse shape that vary greatly and contain minimal features to distinguish a valid pulse from interference. Since traditional demodulation techniques, such as the matched filter, depend greatly on a consistent signal shape and frequency to recover a transmitted signal, other demodulation techniques need to be investigated. An ideal design approach should take into account features from a wide variety of received pulses to detect the desired pulse, often with minute nuances, from noise and other interference.

In recent years, the use of machine learning in medical applications has gained popularity and achieved promising results [Ref. 2]-[Ref. 5]. These applications leverage machine learning to process images or signals with similar features quickly and efficiently to diagnose medical conditions. With machine learning, data that previously required review by a trained doctor could be classified as benign or malignant with high levels of accuracy. Transferring initial review of these medical conditions to machine learning often allows for rapid screening or earlier diagnosis of serious conditions.

During the onset of the COVID-19 pandemic, The White House Office of Science and Technology Policy issued a call to action for AI experts to develop data mining tools that could help answer key questions about the spreading virus. KAGGLE, a subsidiary of GOOGLE INC., sponsored a competition amongst their online AI community, rewarding top submissions. Online competitions such as this reach a community of over 4 million data scientists and drive progress in AI fields. The open-source models designed by the community allow for collaboration and use in various applications. Probably the most widely applied architectures are the convolutional neural network (CNN) models developed during the annual ImageNet Large-Scale Visual Recognition Challenges (ILSVRC). The ILSVRC projects challenge developers to design CNN models capable of classifying large photograph datasets into 1000 different object categories.

Winning models are often utilized by researchers in various fields for application in image classification problems. Modified versions of the 2014 winner, GOOGLENET, have been used to classify skin lesions as benign or malignant melanoma [Ref. 4]. A version of RESNET, the top submission in 2015, has been used in magnetic resonance imaging (MRI) scans for early identification of Alzheimer's disease [Ref. 5]. The disclosed approach, and the example embodiments described herein, in this disclosure utilizes a modified version of the pretrained GOOGLENET architecture to classify information over a communication channel.

The objective of this disclosure, and the example embodiments described herein, is to detect and classify information transmitted over a noisy communication channel utilizing deep learning techniques. This work focuses on the receiver end of the communication channel, specifically post reception filtering, processing, and binary decision making. The deep learning scheme must be trained using minimal data, such as a single train of pulses, from a known transmission preamble. It must then quickly and accurately classify the remainder of the received signal and produce the information bitstream in binary format. This architecture will be tested against raw experimental data comprised of an uncoded bitstream with simple checksum blocks; it is then validated against a simulation signal utilizing a variety of modulation and error control coding techniques to improve classification accuracy.

The methods and systems presented in this disclosure are adapted from current studies in the medical field, which use a machine learning approach for classifying electroencephalograph (EEG) and electrocardiogram (ECG) signals [Ref. 2], [Ref. 3], and [Ref. 5]. In these studies, the wavelet transform is performed on EEG and ECG waveforms to extract features. Many researchers propose training the scalogram image representation of these signals to a pretrained CNN for classification [Ref. 2], [Ref. 5]. Saini, Bindal and Bansal propose a new method of using the wavelet transform to extract features from an ECG signal and introduce these features directly into a k-nearest neighbors classifier [Ref. 3]. The methods disclosed build on these works by capturing only the time slots in which a pulse is expected instead of the entire signal.

In addition to the medical field, deep learning is an area of great interest in the communications research field. Goldsmith and Farsad [Ref. 6] introduce a deep learning approach for training detectors and recovering symbol information over optical and molecular communication channels in real time as the signal is received. Shlezinger et. al [Ref. 7] developed a deep learning-based Viterbi algorithm to predict the channel state information at specific steps of the algorithm to increase estimation accuracy and converge faster than the traditional algorithm. This disclosure introduces the use of CNN estimation values as a decision variable for decoding symbols.

Another powerful tool in communications analysis is the wavelet transformation. Jang and Lee present the use wavelet transformation to identify covert communication channels by comparing the wavelet analysis of normal OFDM frames with the wavelet analysis of OFDM frames containing covert information [Ref. 8]. Wavelet transformation excels at identifying transient characteristics of signals based on the mother wavelet function making it an exceptional tool for covert channel analysis [Ref. 8], [Ref. 9]. The disclosed use of wavelet transformation focuses on the dilation property to analyze a signal over a range of frequencies.

Koss [Ref. 11] presents a multipulse pulse position modulation technique that proposes a solution for generating nonoverlapping sequences to allow for self-synchronizing transmissions, an essential element of simplex communication channels.

This disclosure is divided into four sections, Section 1 introduces basic concepts of forward error correction, wavelet analysis and deep learning techniques to provide the reader with a frame of reference for the experimental environment and nuances of binary decision-making in communication channels. Section 2 presents the method utilized for processing raw time amplitude data into images from the continuous wavelet transformation (CWT) analysis for use in a deep learning classifier. Limitations and various metrics are also reviewed. Section 3 discusses the implementation of these methods and presents the results. Multiple modifications of experimental data are simulated and examined for performance improvement. In Section 4, key contributions are discussed.

### Section 1: BACKGROUND

This section presents concepts fundamental to the disclosed method of using deep learning techniques for detecting and classifying information transmitted via pulses over a noisy communication channel. A brief discussion on modulation techniques is presented to provide background information on potential dataset application. Next, forward error correction (FEC) techniques are discussed to provide current coding solutions for error control and error correction. Finally, the CWT and CNN are discussed to provide technical detail on the tools used by the disclosed approach.

Two prominent modulation techniques useful in pulsed transmission are on-off keying (OOK) and pulse position modulation (PPM).

OOK is achieved by transmitting a logic one bit with an optical pulse and transmitting a logic zero bit with the absence of an optical pulse [Ref. 14], [Ref. 15] as seen in Error! Reference source not found. constant weight codes (CWC) are appended to the end of an encoded message. The CWC is comprised of code words, which when appended to the message give the sequence a constant Hamming weight. This helps ensure that the modulation technique remains simple to implement [Ref. 16].

PPM is achieved by changing the location of the pulse during a time interval t as seen in Error! Reference source not found.(D). This property maintains a fixed duty cycle across the time interval and results in a constant average voltage [Ref. 10].

Unlike PPM, which utilizes a single pulse per symbol frame, multipulse pulse position modulation (MPPM) transmits multiple pulses per symbol frame. Given equal length symbol frames with identical time slot durations, MPPM offers an increase in throughput and a reduced transmission bandwidth [Ref. 17], [Ref. 18]. Additionally, by selecting appropriate MPPM symbols with nonoverlapping sequences, a receiver can self-synchronize to a transmitter [Ref. 11].

MPPM sequences are represented in (Q, p) notation defined by Q time slots with p pulsed slots within each symbol frame. This results in a symbol alphabet of size [Ref. 18] [Ref. 19]

$$M = ( \begin{matrix}Q \\ p\end{matrix} ) . \qquad ( 1 )$$

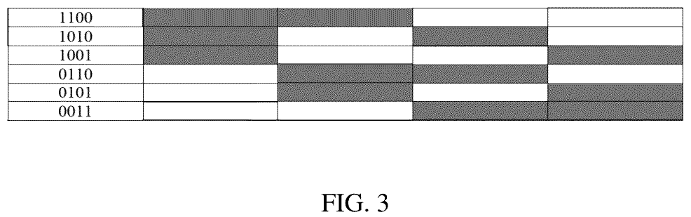

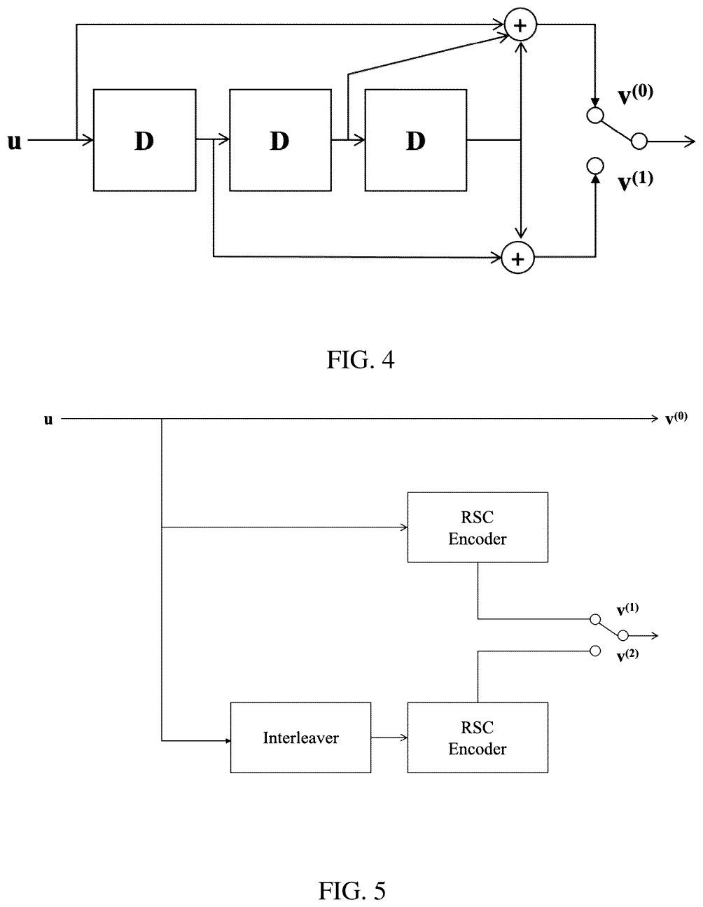

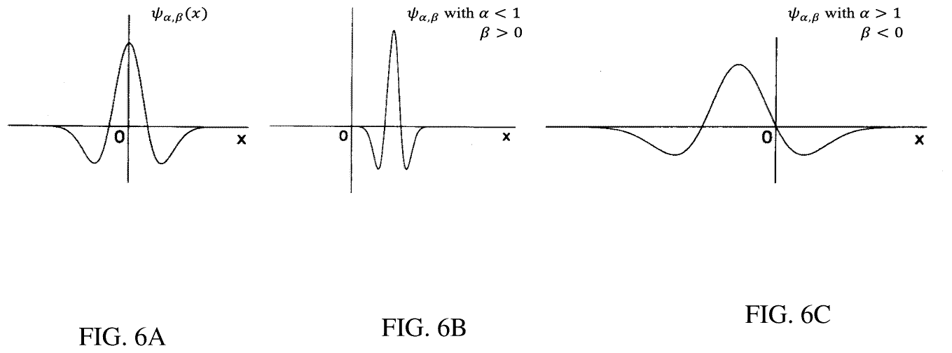

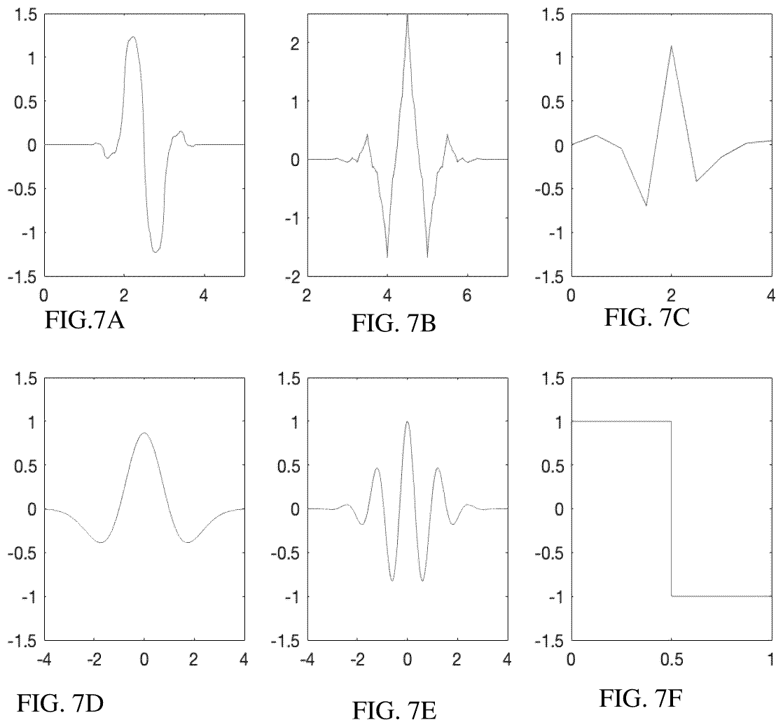

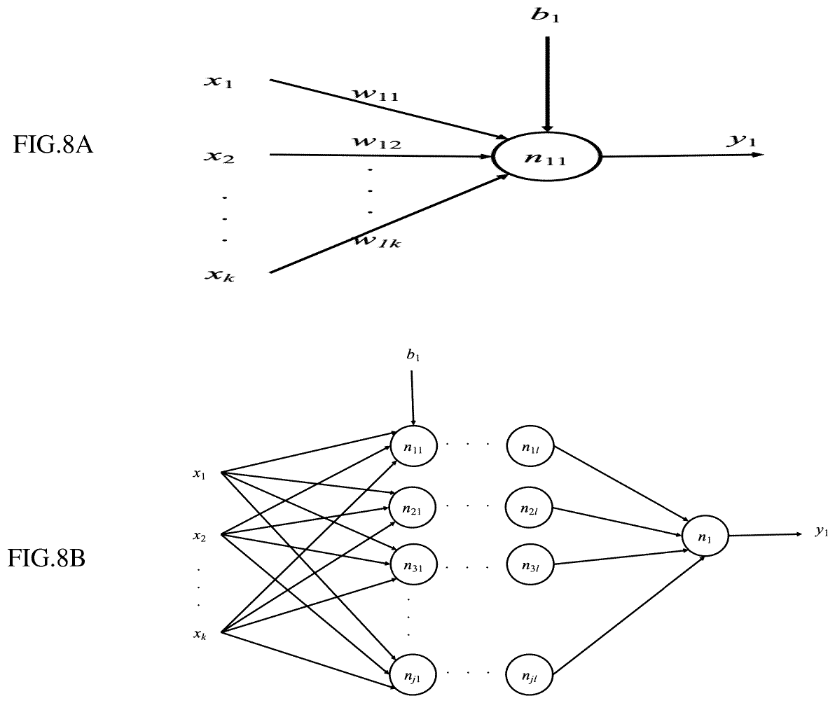

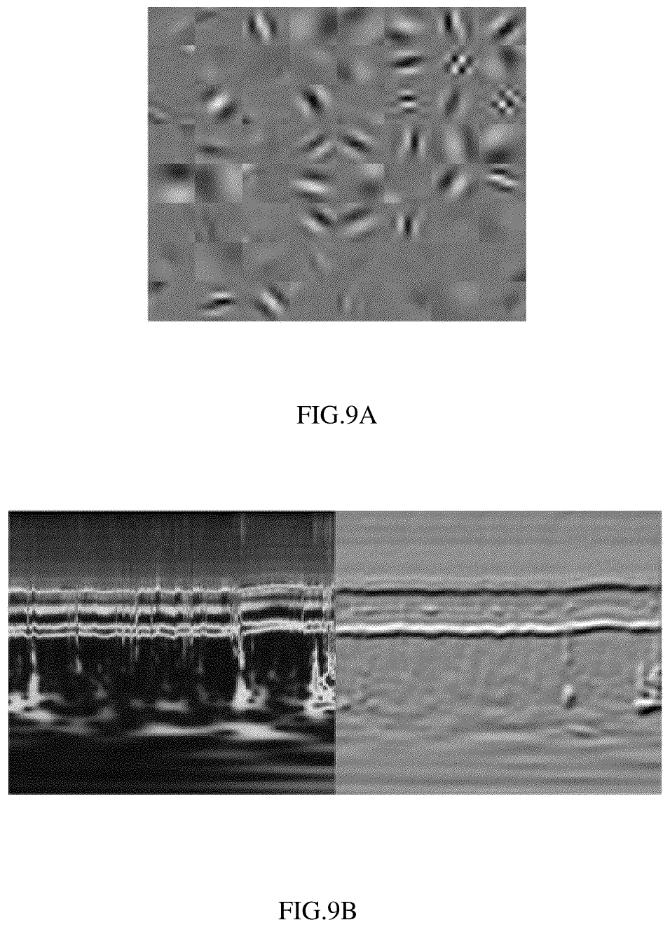

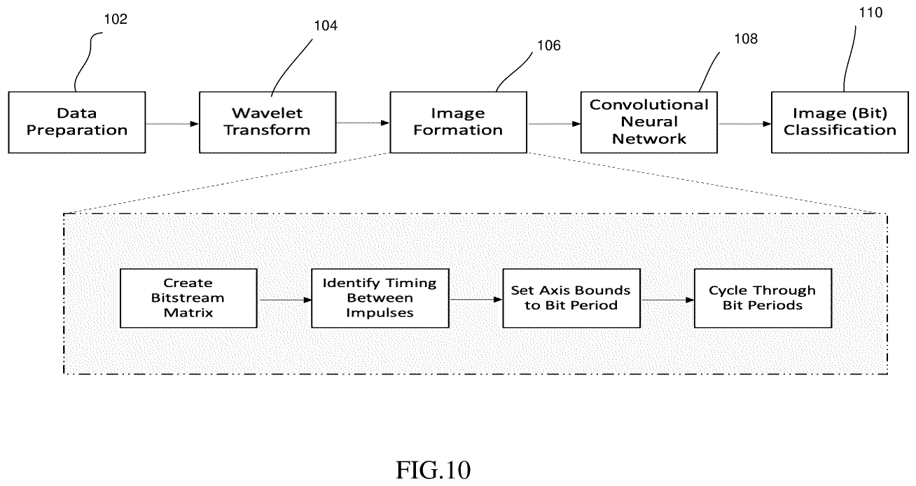

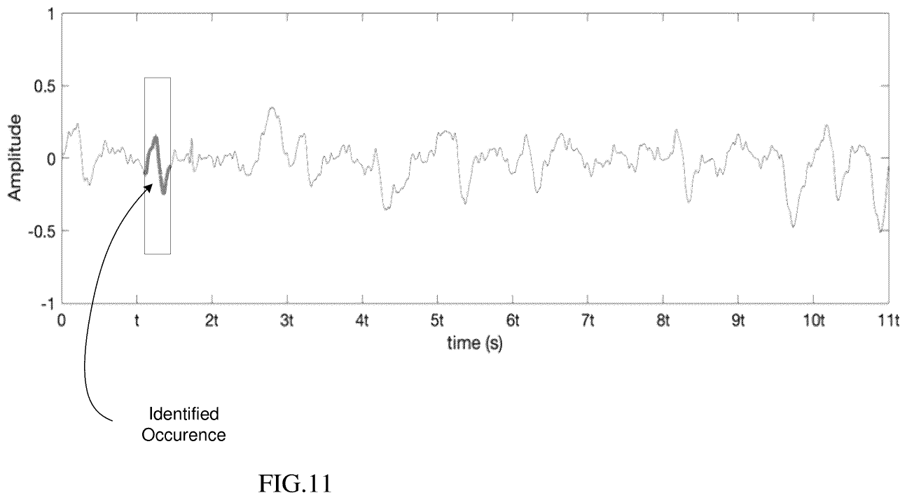

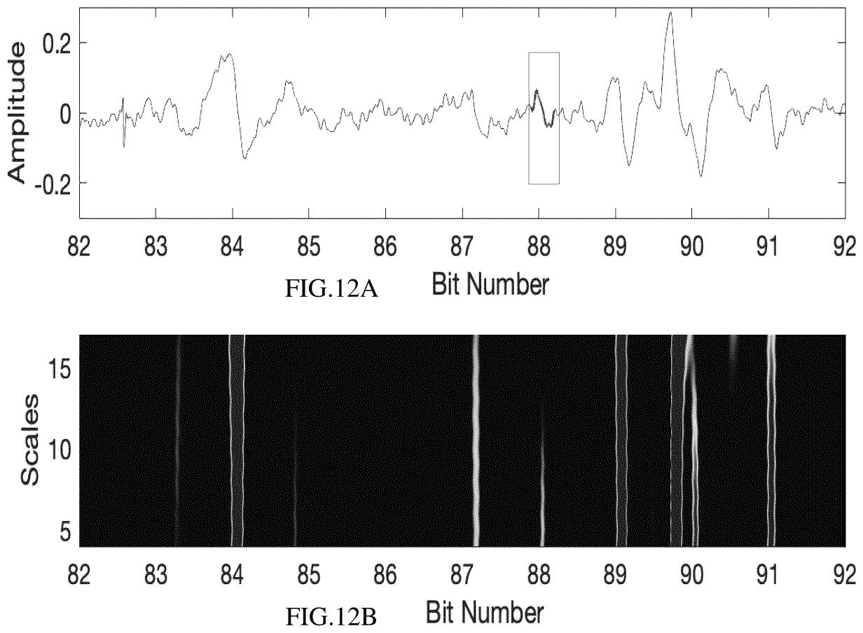

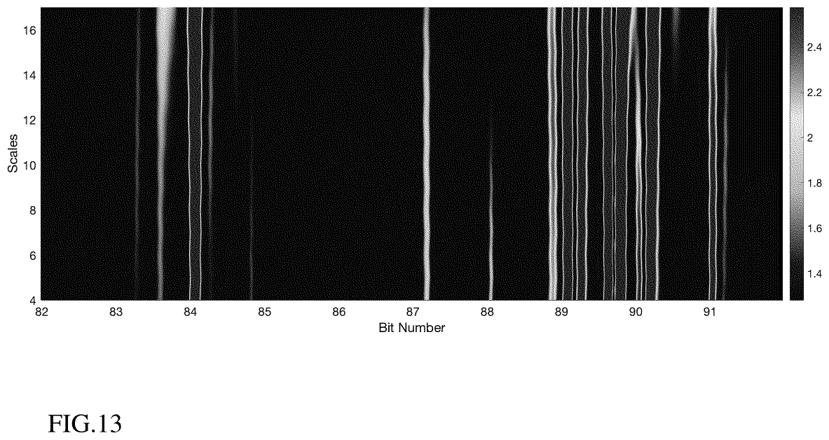

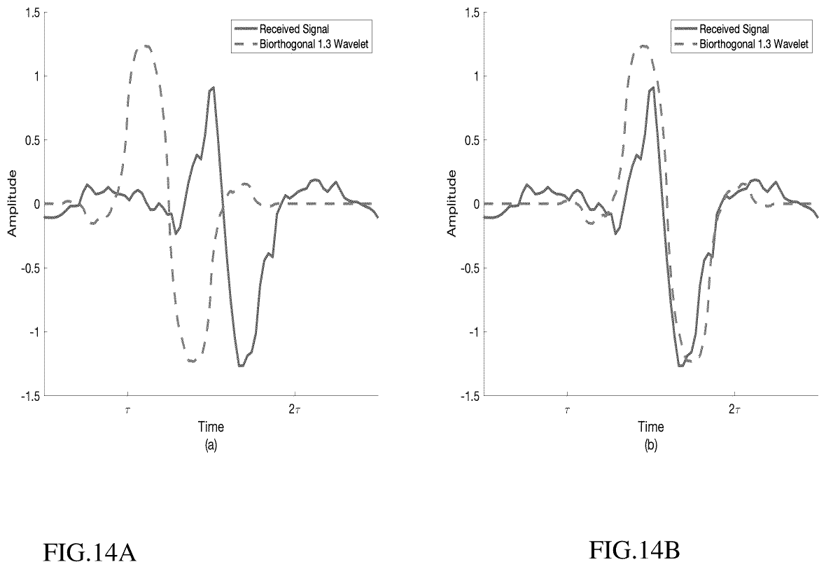

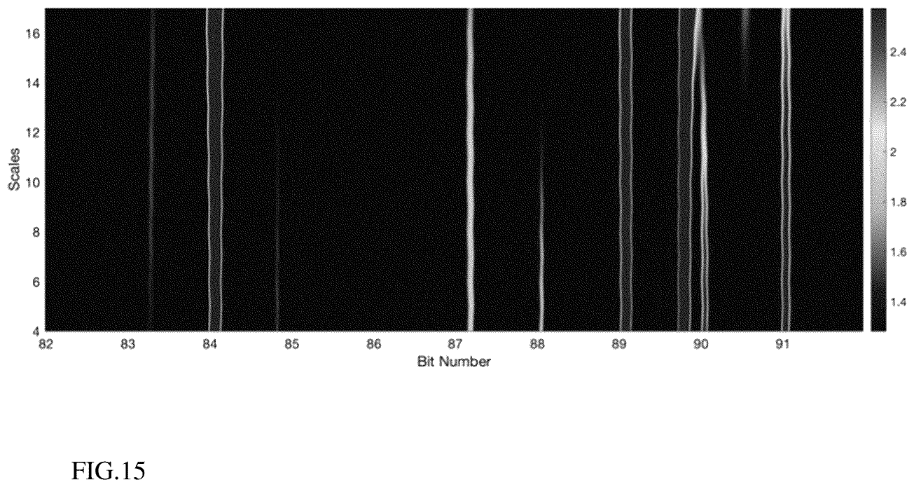

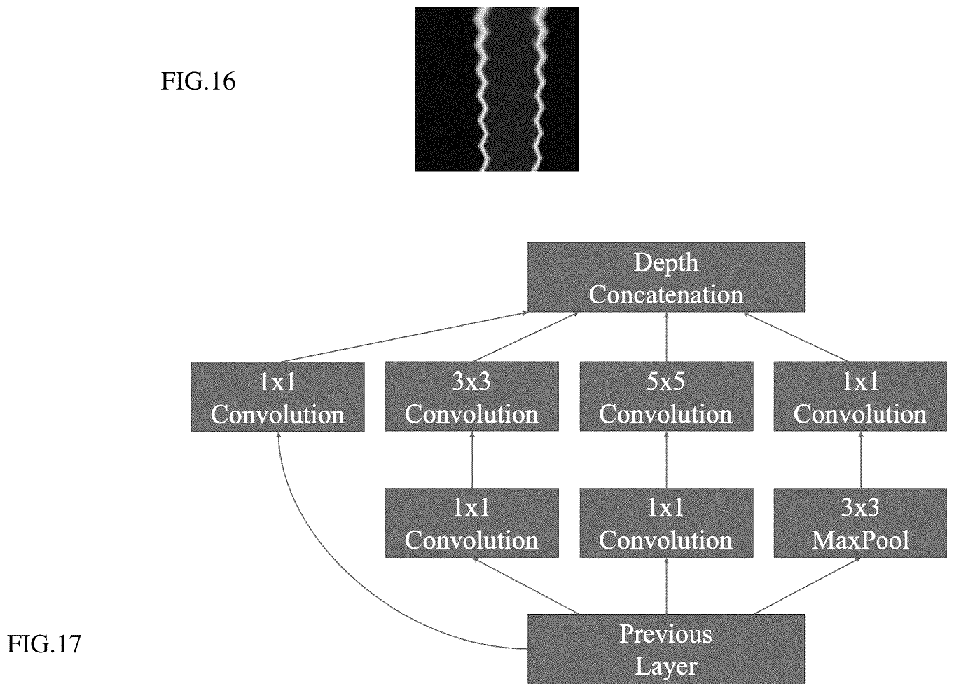

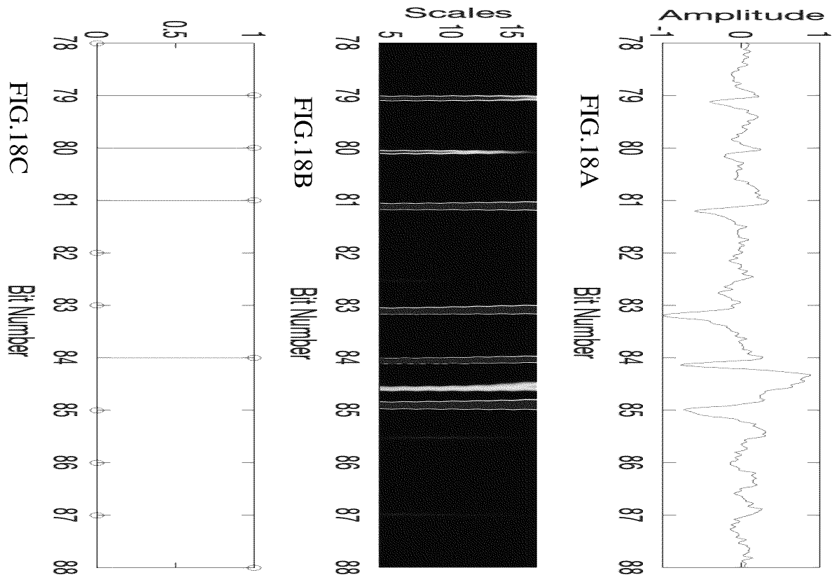

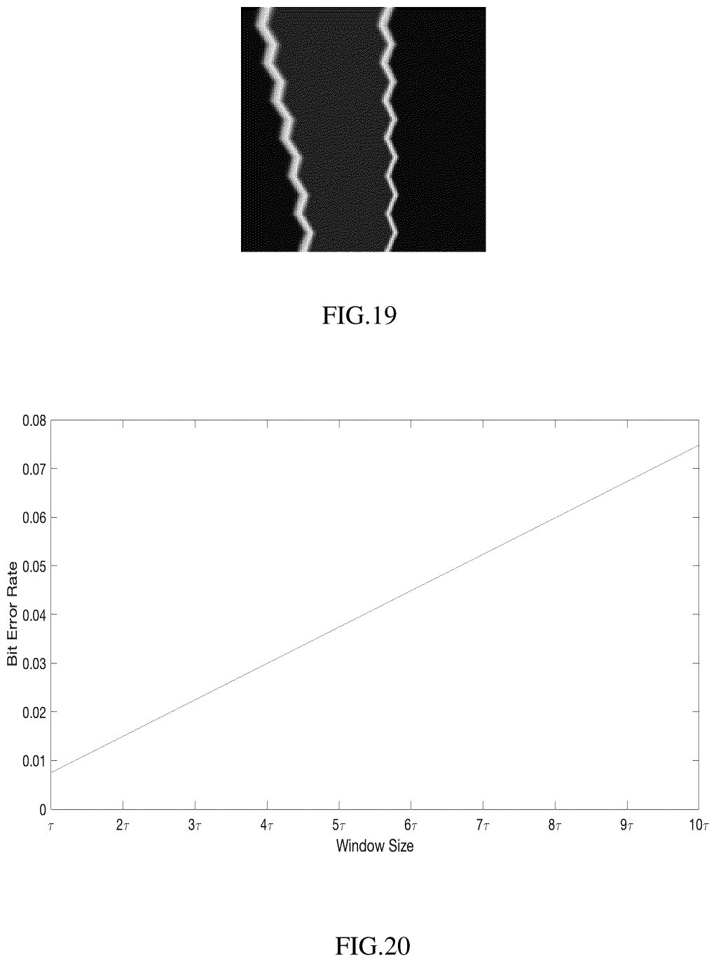

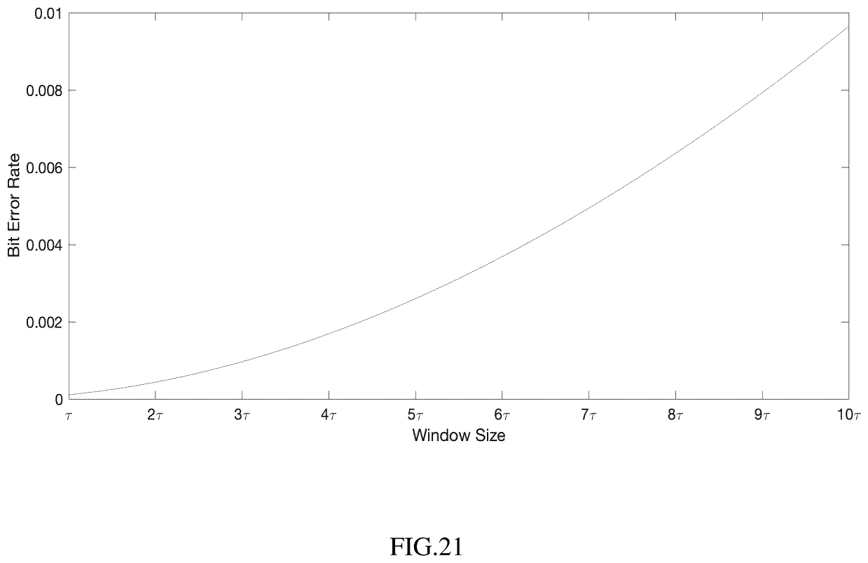

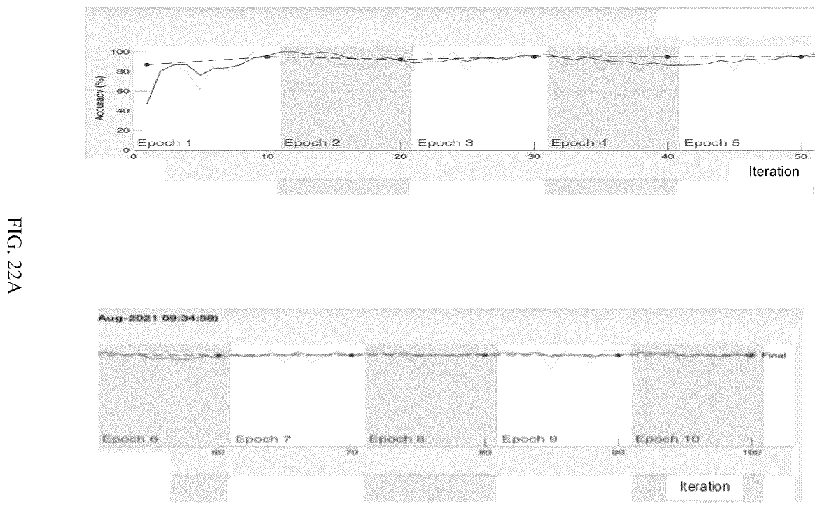

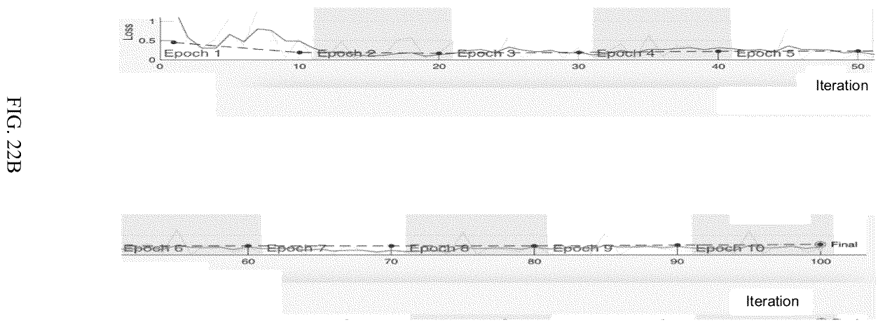

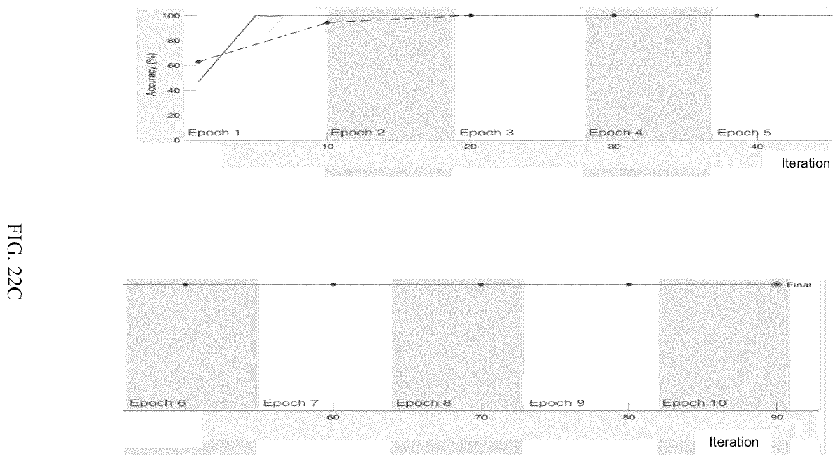

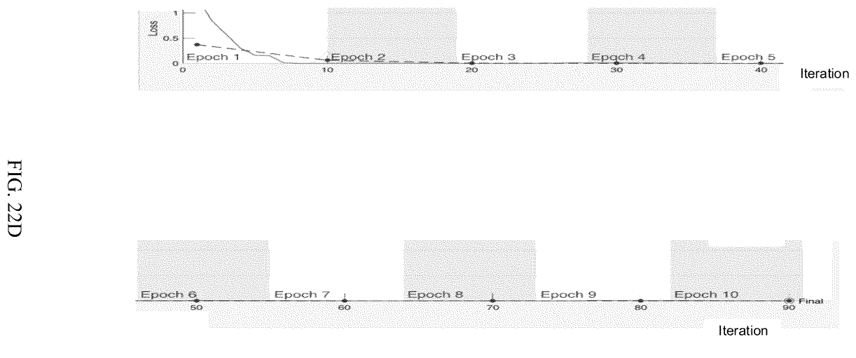

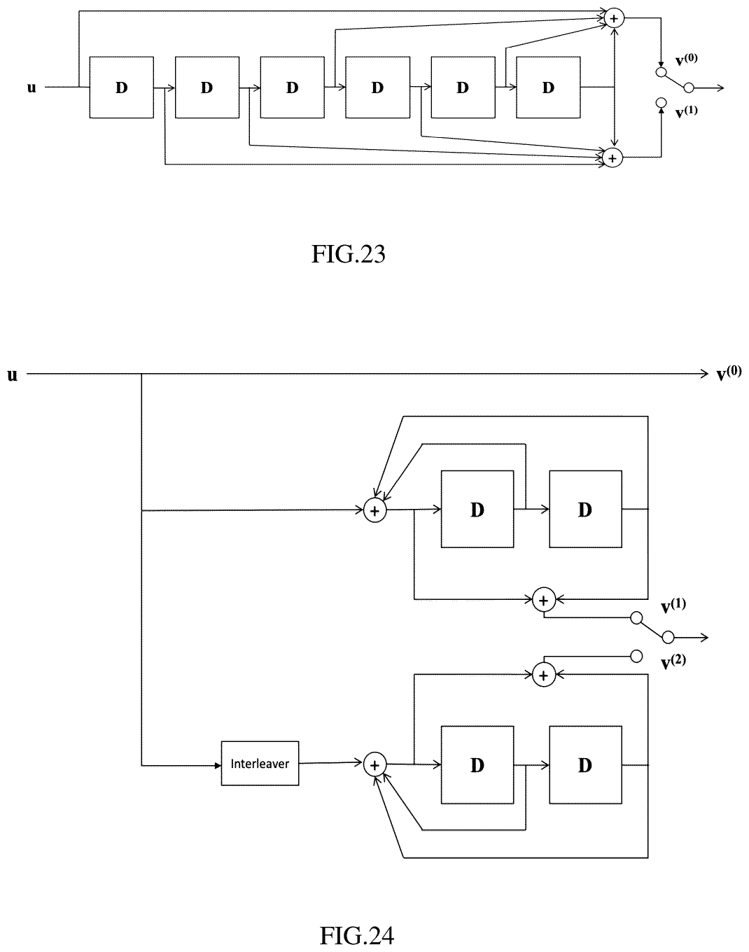

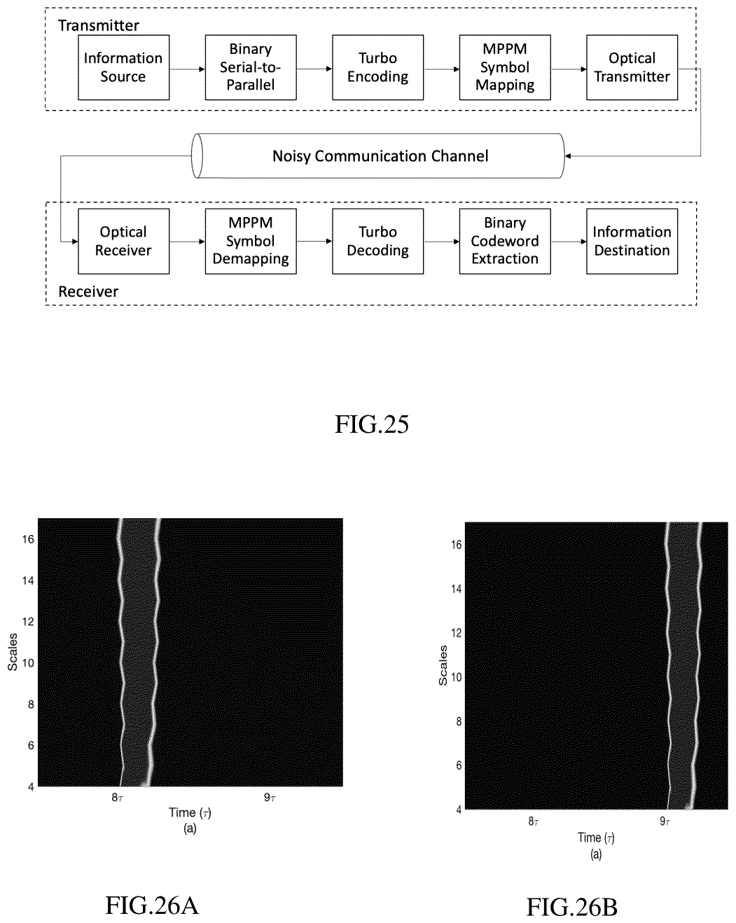

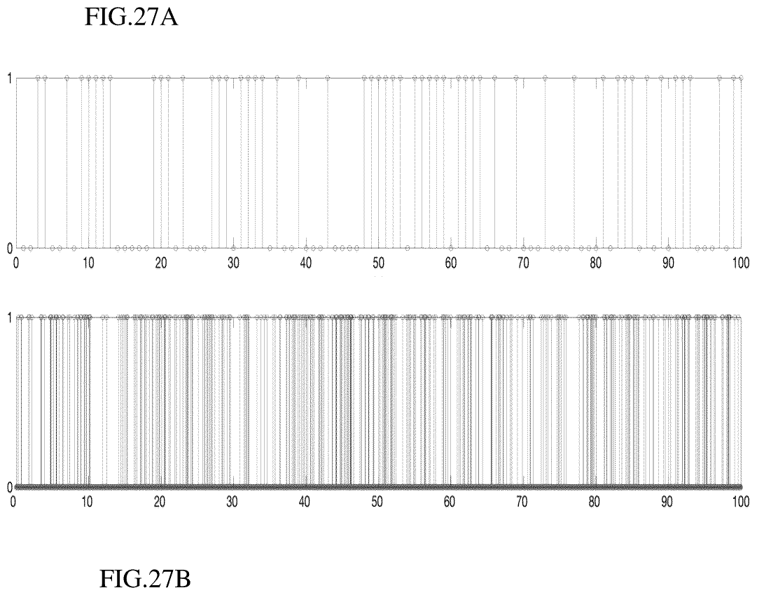

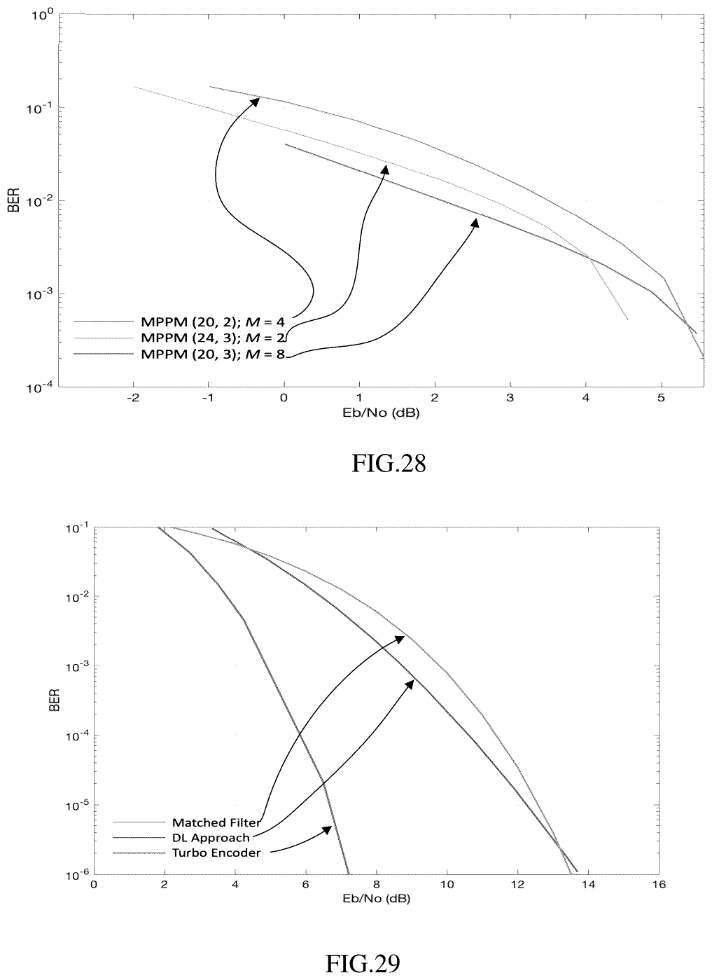

As an example, an MPPM (4, 2) scheme results in a symbol alphabet comprised of six codewords shown in FIG. 3. Without regard to self-synchronous properties, an MPPM scheme is capable of transmitting up to b bits per frame given by b=└ log₂M┘ where └.┘ is the floor operation. In this case, up to two bits may be transmitted per symbol by selecting four symbols for transmission.

In order to self-synchronize, a concatenation of transmitted symbols may not have an overlapping observation in which another valid codeword exists. Transmitting Codeword 5 followed by Codeword 6 results in a transmission sequence of 01010011. The underlined portion of the sequence corresponds to Codeword 2 and indicates that this transmission sequence is not self-synchronous due to overlapping codewords.

Koss [Ref. 11], [Ref. 19] proposes a method for generating self-synchronous symbols by cross-correlating a constrained set of symbols in each M alphabet. This results in an array as shown in Table 1, which indicates the number of non-overlapping combinations for each (Q, p) pair. Within individual array elements, the number of rows indicates the number of solutions available, and the number of columns indicates the alphabet size M. As an example, for (Q, p)=(28,2), there are six unique combinations of eight symbols that maintain self-synchronous properties under an MPPM transmission method. Choosing one of these combinations allows us to transmit eight symbols or three bits per frame.

TABLE 1
Array sizes for self-synchronous MPPM sequences.
Source: [Ref. 11] [Ref. 19]

| (Q ↓, p →) | 2 | 3 | 4 | 5 |
|---|---|---|---|---|
| 14 | — | — | — | — |
| 16 | 4 × 2 | — | — | — |
| 18 | 8 × 3 | — | — | — |
| 20 | 8 × 4 | 6 × 2 | — | — |
| 22 | 7 × 5 | 26 × 2 | — | — |
| 24 | 11 × 6 | 125 × 2 | — | — |
| 26 | 7 × 7 | — | 12 × 2 | — |
| 28 | 6 × 8 | — | 1066 × 8 | — |
| 30 | 8 × 9 | — | — | — |
| 32 | 4 × 10 | — | — | 49 × 3 |

### Forward Error Correction

The use of error correction coding is necessary to ensure accurate decoding of a signal due to the high levels of interference and potentially unreliable communication channels, such as those associated with pulsed transmission [Ref. 20], [Ref. 21]. Additionally, many military communication channels use simplex channels, where no path exists for a receiver to request retransmission of a transmission containing an error. By applying FEC techniques, the receiver can detect these errors and, in many cases, correct a limited number of errors.

Though many FEC techniques exist, this disclosure and the example embodiments described herein, focus on convolutional codes and turbo codes due to their simplicity, versatility, and widespread use. Both techniques are easily modified for employing variable code rates, the ratio of information bits to transmitted bits. Additionally, one study [Ref.22] shows the effectiveness of using turbo codes in OOK schemes, though other coding techniques have also been proposed [Ref. 16], [Ref. 23].

Convolutional codes are produced using the convolution operation of a Boolean polynomial function of length m with an information sequence u. The number of parity bits produced by the encoder determines the overall rate R, a ratio of the number of input bits k to the number of output bits n. As an example, Error! Reference source not found. shows a rate R=½ convolutional encoder with a Boolean polynomial function of length 3, defined by the number of memory elements of a shift register depicted as blocks D. The constraint length vis defined by the sum of the lengths of all shift registers for each input. Convolutional codes are commonly defined by these three values (n, k, v) and governed by [Ref. 21]

$$v = u g \qquad ( 2 )$$

where u is the input sequence, v is the output sequence, and g is the generation sequence defined by the Boolean polynomial function.

Turbo coding utilizes a parallel concatenation of two or more convolutional systematic feedback encoders joined by an interleaver [Ref. 21]. The interleaver reorders the information bit structure, achieving a random code design while maintaining structure for ease of decoding. Because of this, turbo codes perform exceptionally well at low bit error rates (BER) with large block lengths [Ref. 21]. In Error! Reference source not found., two rate R=½ systematic feedback encoders are concatenated to form a turbo encoder. Given a large enough interleaver, the effective rate of a turbo encoder using (n,1, v) systematic encoders is given by [Ref. 21]

$$R \approx \frac{1}{2 n - 1} . \qquad ( 3 )$$

### Continuous Wavelet Transformation

In signal processing and analysis, it is often advantageous to convert a time-amplitude domain signal to the frequency-amplitude domain to reveal certain properties of the signal, useful in filtering the signal and extracting the information sequence. The Fourier transform allows us to convert the original signal into this frequency-amplitude domain. One of the limitations of the Fourier transform, however, is that it presents the average amplitude of individual frequencies contained in the signal sample. Since the entire signal is analyzed at each frequency, the time-location of the individual occurrences of these frequencies is lost. To preserve this information, Gabor developed the windowed Fourier transform, which computes the Fourier transform in shortened time windows of the entire signal sample [Ref. 24]. The result is a time-frequency representation of the signal.

Like the windowed Fourier transform, the CWT produces a time-frequency representation of the signal, but with two important advantages. First, the CWT varies the bandwidth of the filter proportionally to the measured frequency, given by

$$K ≡ \frac{Δ f}{{f}_{0}} . \qquad ( 4 )$$

This provides a much higher time resolution for high-frequency data than available by utilizing the Fourier transform. Second, the CWT utilizes various wavelet functions, optimizing the measurement of the frequency response across various signals. The CWT of a signal f(t) is given by [Ref. 9]

$$CWT \{ f ( t ) , α , β \} = {\int }_{- ∞}^{∞} f ( t ) {ψ}_{α , β}^{*} ( t ) d t \qquad ( 5 )$$

where ψ(t) is a mother wavelet, ψ(t), which has been dilated by α and translated by β as shown in Error! Reference source not found. and defined by [Ref. 25].

$${ψ}_{α , β} ( t ) = \frac{1}{\sqrt{α}} ψ ( \frac{t - β}{α} ) . \qquad ( 6 )$$

These varying time-widths of the wavelet shapes shown in Error! Reference source not found. allow the CWT to locate high-frequency transients in signals much more effectively than the windowed Fourier transform [Ref. 25]. Additionally, since wavelet functions consist of varying shapes as shown in Error! Reference source not found., the CWT produces even greater results searching the signal sample and locating time instances of each frequency matching the shape of the wavelet function.

The frequency of the wavelet can be varied by dilating the wavelet function. In practice, the frequency ranges are called scales and are defined by a set of integers. The signal is processed by each wavelet function dilated by the integers in the defined scale range. The CWT then outputs a matrix of coefficients corresponding to the selected frequencies filtered over the time series of the signal data. Because of their unique ability to locate transient features of a signal, wavelet transformation is an exceptional tool for use in identifying information transmitted over a Redacted communication channel [Ref. 8], [Ref. 9].

### Deep Learning and Convolutional Neural Networks

The neural network is the foundation of many machine learning models. At its core, a neural network is comprised of inputs xₖ, connection weights wⱼₖ, nodes nⱼₗ, a bias bⱼ, and outputs yₗ as shown in Error! Reference source not found.A. Each input is assigned a weight which determines the contribution of that input to the model. These inputs are multiplied by their respective weight, then summed. This weighted sum is passed through an activation function φ( ) producing output y given as [Ref. 26].

$$y = φ ( wx + b ) . \qquad ( 7 )$$

When additional layers of nodes, called hidden layers, are introduced between the input and the output layer, the network is classified as a multi-layer network. Most contemporary neural networks contain more than one hidden layer and are called deep neural networks [Ref. 26]. An example of a deep neural network is shown in Error! Reference source not found.8B.

CNNs are a further subset of deep learning networks that utilize convolution operations in at least one layer [Ref. 27]. These convolution operations extract local features with a high degree of correlation among neighboring input locations, such as edges and corners. These features, or layer activations, are then combined in subsequent layers in which convolution operations are again performed to extract higher order correlations [Ref. 28]. Error! Reference source not found.9A shows a visual representation of 64 example convolution operations performed on RGB images in the first convolutional layer of a CNN. Each of these 64 convolution operations, or channels, are performed over a single image producing an output of 64 activations corresponding to 64 extracted features.

CNNs are primarily used in image processing and object detection applications due to their aptitude in extracting significant features from neighboring pixels and their low computational cost [Ref. 28]. Error! Reference source not found.9B shows the activation output produced by one channel of the CNN layer introduced in Error! Reference source not found.9A. In this example, the 53rd channel extracts the most significant features from the ECG waveform of a person with cardiac arrythmia [Ref. 29]. Studies show that using the wavelet transform to convert a signal to image format produces variation detectable by CNNs for classification [Ref. 2], [Ref. 5].

In summary, this section laid the framework for the process developed for a deep learning approach for detecting signals. Presented was a description of the tools used in the disclosed process and described was the modulation techniques used to achieve a self-synchronizing channel. The following section formally presents the disclosed approach using an experimental signal.

### Methodology

This section presents the disclosed deep learning approach to identifying and classifying bit information. The disclosed approach is shown in Error! Reference source not found.0. Initially, the approach begins by preprocessing the dataset to exploit CWT analysis utilizing the MATLAB CWT application. The CWT coefficients are then converted into scalogram images to train the CNN architecture. The CNN is then utilized to classify incoming signal data and estimate the transmitted bitstream.

### Data Pre-Processing (102)

The time-amplitude domain of the dataset requires some pre-processing to obtain a form suitable for use with the CWT. The received signal r(t) shown in Error! Reference source not found.1 can be modeled as

$$r ( t ) = s ( t ) + n ( t ) + i ( t ) \qquad ( 8 )$$

where s(t) is the desired pulse signal, n(t) is additive white Gaussian noise, and i(t) represents the interference pulses.

The CWT excels at identifying transitory frequencies at high time resolution [Ref. 5]. By selecting the appropriate wavelet function, this enables identification of occurrences of that function as pulse waveforms throughout the signal. An instance of this is identified in Error! Reference source not found.1. The shape of this pulse waveform can be exploited by the CWT to identify the location of the pulses.

### Continuous Wavelet Transformation (104)

Used was a wavelet analyzer application of MATLAB to process the received signal with the CWT. The application includes wavelet functions, each with unique shapes to best filter the received signal and locate transitory frequencies. For an example dataset, the biorthogonal 1.3 wavelet contained most similar shape to the pulse waveform of interest and performed best.

After normalizing the dataset about the amplitude axis by subtracting the mean value from all data points and down sampling the data to increase processing speed, the process filtered the signal using the CWT. The CWT coefficient values are obtained by convolving the input signal with the wavelet function at various frequencies, which are a function of the wavelet center frequency f_{c}, the sampling period Tₛ, and scaling integer N given by

$$f = \{ \frac{{f}_{c}}{{NT}_{s}} : n ∈ {ℤ}^{+} \} . \qquad ( 9 )$$

In practice, wavelets with lower scales corresponding to higher frequencies produce better time resolution. Additionally, they ensure that time locations with low amplitude pulses are not lost by long convolution periods. An example of this is shown in Error! Reference source not found.2A and 12B in which bit position 88 has minimal amplitude. Only the higher frequency wavelets capture this as a valid one bit. According to an example embodiment, the process analyzes the symbol between integer values of 4 and 17 to ensure that frequency variations of pulses such as this are accurately captured.

### Image Formation (106)

When utilizing the CWT to obtain the time-frequency representation of a signal, results are formatted into a matrix of coefficients 122 in which each row signifies the frequency of the wavelet used in the convolution with the input signal. This results in an m×n matrix where m equals the number of frequencies used in the wavelet analysis and n equals the number of time samples of the signal. Table 2 shows an example of the coefficient matrix.

TABLE 2
CWT coefficient values for one pulse duration.

| | Time | | | | | | | |
|---|---|---|---|---|---|---|---|---|
| Scale | 922 | 922.2 | 922.4 | 922.6 | 922.8 | 923 | 923.2 | 923.4 |
| 9 | 0.0266 | 0.087 | 0.141 | 0.1744 | 0.1786 | 0.1526 | 0.1043 | 0.047 |
| 8 | 0.0452 | 0.1007 | 0.1434 | 0.1614 | 0.1501 | 0.1131 | 0.0621 | 0.0106 |
| 7 | 0.0109 | 0.0607 | 0.1064 | 0.1345 | 0.1368 | 0.1136 | 0.0725 | 0.0257 |
| 6 | 0.0267 | 0.0694 | 0.1023 | 0.1151 | 0.1051 | 0.0765 | 0.038 | 0.0002 |
| 5 | 0.0023 | 0.0366 | 0.0685 | 0.0866 | 0.0868 | 0.0709 | 0.044 | 0.0127 |
| 4 | 0.0129 | 0.0398 | 0.0589 | 0.0648 | 0.0585 | 0.0426 | 0.0207 | −0.0018 |

Scalograms can be used to convert this matrix into an image suitable for use in training a CNN. A scalogram displays the coefficient data by representing the percentage of energy for each coefficient as a color on a predefined scale or color axis. The resulting image has an x-axis defined by time, y-axis defined by wavelet frequency, and color-axis defined by coefficient value. The scalogram in Error! Reference source not found.3 depicts a 10-bit window of CWT coefficients obtained using the biorthogonal 1.3 wavelet.

Like in most applications [Ref. 2], [Ref. 5], this scalogram utilizes the absolute value of the coefficients during the scalogram reconstruction. This results in two time periods of large coefficient values for each pulse. This is caused by a period of large negative values when the wavelet is convolved with the signal in time instances immediately before the wavelet shape matches the location of the pulse as shown in Error! Reference source not found.4(A). As the wavelet window continues to slide across the received signal, the wavelet shape matches the same time location as the pulse as shown in Error! Reference source not found.4(B). The convolution operation at this time results in a large positive coefficient value.

By reconstructing only the positive wavelet coefficients in a scalogram, a single period of values is plotted on the scalogram for each pulse as shown in Error! Reference source not found.5. Additionally, locations at which the biorthogonal wavelet window passes a signal response 180 degrees out of phase are filtered out of the scalogram reconstruction, thus reducing the amount of noise in the scalogram.

For compatibility with the GOOGLENET pre-trained CNN, scalogram images must be saved in 224×224×3 RGB format. To minimize the likelihood that an interference pulse occurs within the observed bit window, the reconstructed image must contain only enough time data to ensure that the pulse can be reconstructed by the scalogram. Due to the nature of pulse waveforms in communications channels, the timing of the window can vary greatly. To ensure that the pulse is captured, an appropriate window is three times the length of the pulse period as seen in the reconstruction of the coefficients using a scalogram in Error! Reference source not found.6.

Scaling the color axis of the scalogram by setting an upper threshold and a lower threshold reduces the ambient noise captured during CWT processing. All coefficients less than or equal to the lower threshold on the color axis are mapped to the first color value on the colormap. Likewise, all coefficients greater than or equal to upper threshold value are mapped to the last value on the colormap. The remaining coefficient values are mapped on a linear scale.

Statistical analysis of coefficient values produced best values for minimum and maximum color axis values. Each frequency row of the coefficient matrix was normalized individually. By normalizing each row individually, coefficient values are distributed equally based only on coefficient values within that frequency row. This results in maximum coefficient values at the same time locations as the highest coefficients in other frequency rows. A histogram of all coefficient values was then plotted, indicating that the values followed a near normal distribution. The minimum and maximum color axis values were then chosen as 1.645 and 2.576, respectively, quantile values corresponding to the probabilities of 0.90 and 0.99. This results in only the top 10% of coefficient values being mapped to the color spectrum.

With a suitable color spectrum defined for constructing scalogram, each bit location was then plotted and saved as a Portable Network Graphics (PNG) image. The PNG format preserves RGB values, allowing for proper use in the GoogLeNet CNN. Utilizing the preambles to identify the location of the first transmitted bit, the starting times of each transmission and the bit period were calculated. The observed bit window which captured three times the length of the pulse was centered on the first bit to allow for timing drift of subsequent bits. The transmitted bitstream vector was then imported for image classification. Each bit window was then captured as an image and saved into individual classification folders designated zero bit or one bit, based on the known transmission value.

### Convolutional Neural Network (108)

The method uses a modified version of the GOOGLENET pre-trained architecture designed to classify images. Using a pre-trained architecture designed for similar tasks allows us to achieve a high level of classification accuracy without large amounts of training data, a process known as transfer learning. GOOGLENET is a 22-layer CNN first proposed in [Ref. 30]. The network utilizes Inception layers that perform multiple convolution calculations within sublayers, which are concatenated to produce a single layer output shown in Error! Reference source not found.7. The Inception network is then a network of stacked Inception layers occasionally separated by max-pooling layers, which reduce the image size and are designed to halve the resolution of the grid and prevent the increase of computational complexity [Ref. 30].

To utilize GOOGLENET for the disclosed application, three layers are modified from the original architecture. First, the dropout layer is modified, increasing dropout probability from 0.5 to 0.6. Next, the fully connected classification layer is reduced from 1000 filters, the default number of classes utilized by GOOGLENET during ILSVRC. Since the images are being classified by a single bit, only two filters are used. Finally, the output classification layer is replaced by a new classification layer without labels since these are assigned by the trainNetwork function within MATLAB based on image directory naming.

After modifying GOOGLENET, achieved is transfer learning for application with communications data by retraining the CNN with a subset of obtained scalogram images. The images are divided into two groups, a training dataset consisting of 80% of all images and a validation dataset consisting of the remaining 20%. Additional parameters defined include batch size, number of epochs, validation frequency, and initial learning rate. Each epoch trains off the entire training dataset. This results in nᵢ iterations per epoch where nᵢ equals the number of images per batch size. The validation frequency determines how often the validation dataset is evaluated using the trained model. A validation frequency of 10 tests the model accuracy every 10 iterations. Finally, initial learning rate controls the rate at which the model learns and was set to 0.0003.

### Image/Bit Classification (110)

After training the CNN utilizing a training and validation set with known bitstreams, the scheme can then be used to classify images obtained from an unknown bitstream. Training the GOOGLENET CNN using transfer learning takes approximately 15 minutes using 756 images split into training and validation sets. Once complete, using the model to classify a test dataset of 108 unintroduced images into a predicted bitstream takes just 6.3 seconds. This trained network is then used to determine bit information of future received signals.

In summary, in this section, presented is a formal approach for detecting bit information in a pulsed communication signal using a deep learning approach. An experimental dataset was analyzed to validate the methodology and establish the disclosed process as a solution to processing real-life data. The next section presents results and establishes further channel improvement through simulation data.

### Section 3: Implementation and Results

This section details the application of the methods from Section 2 to an experimental dataset. Final CNN training results and bit error rates (BER) are presented, followed by a discussion on Poisson distributed noise interference pulses. FEC schemes, multiple-transmitter scenarios and MPPM techniques are discussed as solutions to these interference pulses. Simulations using extracted signal properties from experimental data validate the results of the analysis of experimental data and allow research into coding techniques to further reduce BER. Results of performance using these techniques are presented with a recommendation on implementation.

### Performance Metric

Communication system performance is typically evaluated by the BER of the channel at different signal-to-noise ratios (SNR). These values are typically calculated from data obtained from transmissions of greater than one million bits and using traditional demodulation techniques that employ mathematical operations to determine bit information. Since the disclosed method utilizes a deep learning approach to classifying bit information, using the BER alone is not an effective method of determining performance.

BER is computed as the ratio of bit errors observed over a transmission length. The complement of the BER can be thought of as the accuracy, or the ratio of correctly classified samples and overall samples [Ref. 31]. Though this provides a good metric to compare to other communication channels, the accuracy does not provide a reasonable comparison among machine learning classifiers due to the overoptimistic estimation dominated by the largest classifier [Ref. 31]-[Ref. 33]. One effective metric commonly used in machine learning applications is the Matthews correlation coefficient (MCC).

The MCC is given by [Ref. 31]

$${ρ}_{M C C} = \frac{{N}_{T P} {N}_{T N} - {N}_{F P} {N}_{F N}}{\sqrt{( {N}_{T P} + {N}_{F P} ) ( {N}_{T P} + {N}_{F N} ) ( {N}_{T N} + {N}_{F P} ) ( {N}_{T N} + {N}_{F N} )}} \qquad ( 10 )$$

where N_{TP}, N_{TN}, N_{FP}, and N_{FN} are the number of true positives, true negatives, false positives, and false negatives, respectively. The MCC takes into account all four binary metrics whereas the BER only utilizes two metrics. Due to the short sequence length utilized for experimental analysis, the MCC provides a better metric for measuring the effectiveness of the disclosed approach.

### Implementation

Applying the disclosed scheme to a dataset, demonstrated is the effectiveness of utilizing machine learning in a pulsed communications signal. For an example implementation, the dataset contained eight transmissions of 108 bits each. The first seven transmissions were used for the training and validation sets, with an 80/20 split, respectively. The eighth transmission was reserved as a test set to test the scheme after initial vetting by the validation set. By not introducing the eighth transmission into the training process, it is ensured that overfitting did not occur during the transfer learning process.

Since the bitstream (ground truth) for the final transmission is known, the accuracy of the CNN for bit classification was able to be evaluated. Applying the eighth 108-bit transmission to the trained CNN resulted in three bit errors or a BER of 2.78%. Most notably, the predicted bitstream did not contain any false negatives, only false positives. Though the BER is high compared to most communications methods, applying the MCC to the results allows the evaluation of the performance of the disclosed deep learning approach to detecting pulses [Ref. 31]. The MCC for the eighth transmission is 0.968 on a [−1,1] scale indicating that the disclosed method using the GOOGLENET CNN for impulse signal detection is highly accurate.

Error! Reference source not found.18A-18C show the experimental results of the eighth transmission. By examining the incorrectly predicted bits, a basis for each error can be detected. For example, a zero bit was transmitted in bit position 83 seen in Error! Reference source not found.18(C). Comparing Error! Reference source not found.18(B) to Error! Reference source not found.18(C) indicates that the image capture for bit position 83 contained an unintended interference pulse, shown in Error! Reference source not found.19.

### Poisson Noise Interference

Upon further investigation, it is determined that the false positives predicted by the CNN resulted from interference pulses. These unintended pulses occur intermittently throughout the transmission period and can be modelled using the Poisson distribution, having a probability mass function (PMF) given by [Ref. 34]

$$\begin{matrix}{f}_{K} [ k ] = \frac{{α}^{k} {e}^{- α}}{k !} & 0 \leq k < ∞\end{matrix} \qquad ( 11 )$$

with the average number of events a equal to the product of the rate of arrival λ and time interval t. By counting the number of interference pulses that occurred during the eighth transmission window, it is estimated the rate of arrival λ uis 0.014953 interferences per unit time.

Given this PMF, it is estimated that the BER for future transmissions is given by calculating the number of errors Ne given by

$${N}_{e} = \frac{{T}_{w}}{{T}_{b}} E [ X ] P ( {0}_{tx} ) \qquad ( 12 )$$

where T_{w} is the bit window length, T_{b} is the bit period, and P(0ₜₓ) is the probability a zero bit was transmitted. Interference pulses that occur during a bit position containing a transmitted bit one result in constructive interference and sufficiently large coefficients for the CNN to predict a bit one. Interference pulses that occur during bit positions containing a transmitted bit zero are mistaken as a transmitted bit one and must be accounted for when estimating the BER. For Poisson distribution, a is given by

$$α = E [ X ] . \qquad ( 13 )$$

Substituting Equation (13) into Equation (12) and replacing α with λₜ yields

$${N}_{e} = \frac{{T}_{w}}{{T}_{b}} λ t P ( {0}_{tx} ) \qquad ( 14 )$$

Since the time interval t is the product of the number of bits in a transmission N_{b} and the bit period T_{b}, Equation (14) can be rewritten as

$${N}_{e} = \frac{{T}_{w}}{{T}_{b}} λ {N}_{b} {T}_{b} P ( {0}_{tx} ) . \qquad ( 15 )$$

Simplifying, obtained is a BER or P_{b} for a transmission as

$${P}_{b} = {T}_{w} λ P ( {0}_{tx} ) . \qquad ( 16 )$$

Error! Reference source not found.0 shows the linear relationship between the window size and the BER for a scheme without error correction.

The appropriate window size is greatly dependent on the time drift of the pulse waveform. According to an example embodiment dataset, the timing drift required a window three times the width of the pulse. In systems with minimal drift, a bit window could be reduced to the length of the pulse.

### Multiple Transmitter Performance

One solution to further reduce the impact of interference pulses is to transmit the data over two communications channels (i.e., two transmitters and one receiver). Though this reduces the data rate by a factor of two, it drastically improves the BER of the channel. With multichannel propagation, only bit windows in which both channels transmitted a one bit are identified by the receiver as a one bit. Take for instance a zero bit decoded via the first channel and a one bit decoded via the second. Since the disclosed reception method reliably decodes one bits, the absence of a pulse waveform in the first channel is assumed to be a zero bit correctly transmitted by the first channel and an interference pulse transmitted by the second channel.

Assuming no errors caused by false negatives, a bit error occurs only when both channels experience an interference pulse. If both transmitters act independently, the joint probability both channels experiencing one or more interference pulse is derived from Equation (11) and given by

$$P ( X > k , Y > l ) = {\sum }_{k = 1}^{∞} {\sum }_{l = 1}^{∞} \frac{{α}^{k + l} {e}^{- 2 α}}{k ! l !} . \qquad ( 17 )$$

Since the two interference pulses must occur in the same bit position, only a single bit window is considered in the joint probability calculation. Additionally, since a bit error only occurs during zero-bit transmissions, the BER for a two-transmitter scenario is the product of the probability of both channels experiencing an interference pulse and the probability that a zero bit was transmitted.

$${P}_{b} = {\sum }_{k = 1}^{∞} {\sum }_{l = 1}^{∞} \frac{{( λ t )}^{k + 1} {e}^{- 2 λ t}}{k ! l !} P ( {0}_{tx} ) . \qquad ( 18 )$$

Error! Reference source not found.1 shows the exponential relationship between the window size and the BER for an application without FEC applied. By utilizing a second transmitter, BER decreases significantly without a reduction in bitrate typically associated with FEC schemes.

### Forward Error Correction

Utilizing FEC schemes for transmission has proven effective in correcting false positives caused by interference pulses. Initial trials on experimental data utilizing a rate R=½ convolution encoder with constraint length three and a free distance of three successfully corrected all bit errors in a 108-bit transmission. Generally, hard decision decoding can correct one error every constraint length. Utilizing Equation (18), the probability of two or more errors occurring during a constraint length is 0.0022. This led to an improved BER of approximately 10⁻³.

To validate these results observed in the experimental data, a simulation test signal was created to increase the number of transmitted bits, simulate increased levels of interference pulses, and allow implementation of additional FEC coding schemes including additional convolutional codes and turbo codes. To test the equivalence of the simulation signal with the experimental signal, the transmission scheme of the experimental data is replicated with the same 864-bit sequence and introduced interference pulses at the same arrival rate. In trials with the experimental data without a FEC correction scheme, achieved is a 2.78% BER. After conducting transfer learning, GOOGLENET classified the simulation bits with 97.57% accuracy, or a 2.43% BER. This shows that the simulation data achieves similar performance and is appropriate for further testing.

When introducing interference pulses, used is a multiple of the baseline number of interferers modeled by the rate of arrival λ defined in Equation (11) and calculated from experimental data. This allows us to explore the noise limits which impact the correction capability of the FEC schemes. When generating training data for the CNN, no interference pulses were introduced into the simulation signal. This ensured that zero-bit windows did not include unintended pulses and resulted in a perfect training set with 100% validation accuracy show in Error! Reference source not found.2 (B). In initial CNN trials, interference pulses were included in the training data. In time slots where a zero bit was transmitted and an interference pulse occurred, the captured image appears identical to a one-bit capture. When included in the training dataset, the CNN tends to classify one bits with a pulse similar to the interference pulse as a zero bit. By training with no interference pulses, the probability of these false negatives was reduced.

TABLE 3
Training parameters for simulation data.

| | Interference Pulses | No Interference Pulses |
|---|---|---|
| Validation Accuracy | 94.74% | 100% |
| Epochs | 10 | 10 |
| Iterations | 100 | 90 |
| Validation Frequency | 10 | 10 |
| Learning Rate | 0.0003 | 0.0003 |

After training the CNN, generated is a sequence of 500 bits encoded with a rate R=½ convolutional encoder shown in Error! Reference source not found.3 with constraint length six and a free distance of eight [Ref. 35] to obtain an encoded sequence of 1000 bits. Five interference pulse models were generated with increasing arrival rates, with the number of interference pulses ranging from 132 to 782 over the 1000-bit sequence as seen in Table 4. This simulation confirms an expected BER given by Equation (16).

TABLE 4
Variable arrival rates of interference pulses applied
to a rate R = 1/2 convolutional encoder.

| Arrival Rate | λ | 2λ | 3λ | 4λ | 5λ |
|---|---|---|---|---|---|
| Interferers | 132 | 285 | 448 | 584 | 782 |
| GoogLeNet | 98.80% | 96.79% | 93.69% | 94.33% | 89.90% |
| FEC | 100.00% | 99.80% | 94.59% | 95.43% | 80.80% |

Then simulated was the use of four additional convolutional encoders presented in Table 5. Each encoder generated a code sequence of 1000 bits with an interference arrival rate of 3λ applied. The convolutional encoder with constraint length three and a free distance of five performed best. This encoder can correct up to two errors each constraint length. Since the interference pulses follow a Poisson distribution, bit errors occur independently of each other. This indicates that burst errors are not likely to occur in this transmission method. In general, convolutional encoders can correct t errors every constraint length given by [Ref. 36]

$$t \leq ⌊ \frac{{d}_{free} - 1}{2} ⌋ . \qquad ( 20 )$$

Accordingly, selecting a convolutional encoder with a high t to constraint length ratio maximizes error correction capability in the presence of interference pulses.

TABLE 5
Rate R = 1/2 convolutional encoders.

| | Arrival Rate | | | | |
|---|---|---|---|---|---|
| | ν = 3, | ν = 6, | ν = 7, | ν = 9, | ν = 13, |
| | d_{free} = 5 | d_{free} = 8 | d_{free} = 10 | d_{free} = 12 | d_{free} = 16 |
| Interferers | 449 | 449 | 449 | 449 | 449 |
| GoogLeNet | 94.79% | 94.19% | 94.29% | 95.19% | 94.59% |
| FEC | 100% | 98.20% | 90.18% | 97.60% | 97.19% |
| t | 2 | 3 | 4 | 5 | 7 |
| t/v | 2/3 | 1/2 | 4/7 | 5/9 | 7/13 |

After evaluating the error correction capability of these convolutional encoders, applied is the best convolutional encoder to a turbo coding scheme shown in Error! Reference source not found.4. The constraint length three convolutional encoder was chosen since it has the highest t to constraint length ratio of the tested encoders from Table 5. By using a parallel concatenated convolutional turbo encoder, the effective rate of the turbo encoder decreases from ½ to ⅓. Though this reduces the throughput of the communications system the BER greatly decreases in extremely high interference pulse rate environments as seen in Table 6.

TABLE 6
Rate R = 1/2 convolution encoder versus turbo encoder.

| Arrival Rate | λ | 2λ | 3λ | 4λ | 5λ |
|---|---|---|---|---|---|
| Convolutional | 99.41% | 98.60% | 99.20% | 96.66% | 95.6% |
| Encoder | | | | | |
| Turbo | 100.00% | 100% | 100% | 100% | 100% |
| Encoder | | | | | |

### Multipulse Pulse Position Modulation Performance

Applying MPPM techniques after turbo encoding allows for even greater resistance to noise caused by high interference pulse rate. In simple transmission techniques utilizing only turbo encoding, achieved is a 100% FEC capability up to an interference arrival rate of 52. By further encoding data using MPPM techniques as shown in Error! Reference source not found.5 and disclosed by Koss [Ref. 11], achieved is a 100% FEC capability up to an interference rate of 32λ.

In a first implementation, utilized was a MPPM scheme in which three pulses are transmitted over 20 time slots. To maintain self-synchronous properties of the MPPM coding scheme, mapped are two symbols, choosing the two symbols with the greatest Hamming and Manhattan distances between the symbol alphabet. In this case, mapped is a zero bit to z₄ and a one bit to z₆ as shown in Table 7.

TABLE 7
Symbol Alphabet: zᵢ ∈ Z_{(20, 3)}|zᵢ = {z₁, . . . , z₆}. Source: [19].

| | q | | | | | | | | | | | | | | | | | | | |
|---|---|---|---|---|---|---|---|---|---|---|---|---|---|---|---|---|---|---|---|---|
| zᵢ | 1 | 2 | 3 | 4 | 5 | 6 | 7 | 8 | 9 | 10 | 11 | 12 | 13 | 14 | 15 | 16 | 17 | 18 | 19 | 20 |
| z₁ | 5 | 0 | 0 | 0 | 0 | 0 | 5 | 0 | 0 | 0 | 0 | 0 | 5 | 0 | 0 | 0 | 0 | 0 | 0 | 0 |
| z₂ | 5 | 0 | 0 | 0 | 0 | 0 | 5 | 0 | 0 | 0 | 0 | 0 | 0 | 5 | 0 | 0 | 0 | 0 | 0 | 0 |
| z₃ | 5 | 0 | 0 | 0 | 0 | 0 | 5 | 0 | 0 | 0 | 0 | 0 | 0 | 0 | 5 | 0 | 0 | 0 | 0 | 0 |
| z₄ | 5 | 0 | 0 | 0 | 0 | 0 | 0 | 5 | 0 | 0 | 0 | 0 | 0 | 5 | 0 | 0 | 0 | 0 | 0 | 0 |
| z₅ | 5 | 0 | 0 | 0 | 0 | 0 | 0 | 5 | 0 | 0 | 0 | 0 | 0 | 0 | 5 | 0 | 0 | 0 | 0 | 0 |
| z₆ | 5 | 0 | 0 | 0 | 0 | 0 | 0 | 0 | 5 | 0 | 0 | 0 | 0 | 0 | 5 | 0 | 0 | 0 | 0 | 0 |

In the implementation of MPPM mapping, several assumptions were made. First, it is assumed that the receiver can self-synchronize and identify the synchronization pulse, or the pulse shown in the first time slot. This allows us to obtain image captures of only the first, eighth, ninth, fourteenth, and fifteenth time slots. Second, assumed is the timing drift of the received pulses. This assumption is based on experimental results, which indicate that transmitted pulses drift at a rate up to three times the length of the pulse. Without this assumption, a more accurate timing would allow for a single image capture to occur over two time slots. The location of the pulse over the single image capture would determine whether the pulse corresponded to the eighth and fourteenth time slots or the ninth and fifteenth time slots, shown in Error! Reference source not found.6.

The information obtained from the CNN output predictions can be leveraged to increase the accuracy of pulse detection and symbol de-mapping. The CNN outputs predictions in a two-column array, with the first column indicating the probability that the captured timeslot represents a zero bit or P(B₀) and the second column indicating the probability that the captured timeslot represents a one bit or P(B₁) given by

$$P ( {B}_{1} ) = 1 - P ( {B}_{0} ) . \qquad ( 21 )$$

An example output is shown in Table 8. Selecting the highest value from the table, the MPPM coding scheme is de-mapped according to that timeslot value. In the example from Table 8, the highest value corresponds to P(B₁) in time slot 9. In the mapping scheme from Table 7, the time slots analyzed are of sequence 11010 for a zero bit or 10101 for a one bit. In this case, the highest value prediction indicates that a 10101 was mapped by the MPPM scheme and is correctly de-mapped as a transmitted zero bit.

TABLE 8
CNN output predictions.

| Time Slot | P(B₀) | P(B₁) |
|---|---|---|
| 1 | 0.029322516 | 0.97067744 |
| 8 | 6.7717878e−08 | 0.99999988 |
| 9 | 1.9995074e−09 | 1 |
| 14 | 0.99999642 | 3.6135198e−06 |
| 15 | 1 | 4.7247815e−09 |

Observation of the images associated with the predictions indicates that the highest value predictions most often occur in time slots in which no interference pulse is present. By selecting the highest prediction value, the method can tolerate interference pulses occurring in up to three out of four time slots which contain sequence pulses. In many cases, the CNN output predictions correctly identified the MPPM sequence in which interference pulses occurred in all four sequence pulses. By encoding data using MPPM techniques, achieved is 100% FEC capability up to an interference rate of 32λ. Error! Reference source not found.27 shows a comparison of the number of transmitted pulses and interference pulses over 100 time slots, highlighting the high resistance to interference noise provided by MPPM coding.

The most notable disadvantage to using a MPPM sequence for transmission is the reduction in throughput. In the previous example, each transmitted symbol mapped to one information bit. To transmit that one information bit, three pulses over a length of 20 time slots was required. Koss [Ref. 11] proposes that in application, a cooling off period is required for pulse transmission, such as charging a pulse generator, discharging the pulse, or any other delay required before transmitting a subsequent pulse. This requirement reduces the impact of unused time slots in a transmission sequence and results in an effective reduction in throughput of ⅓. By utilizing the CNN output predictions, the method offsets the loss in throughput with additional error correction capability.

Another way to offset the reduction in throughput is to select a MPPM scheme with a higher number of non-interfering symbols. In order to transmit b bits, M symbols must be available, i.e., M=₂^{b}. In the previous example, a maximum of two separate symbols may be transmitted to maintain self-synchronous properties. This results in one information bit per transmitted symbol. By increasing the number of symbols in a self-synchronous set, the number of information bits per transmitted symbol is increased. Three MPPM schemes were simulated with the number of symbols in a set

M={2,4,8}

corresponding to

b={1,2,3}

information bits transmitted per symbol shown in Error! Reference source not found.28. By increasing the number of symbols in a set, the method can recover the reduction in bit rate due to FEC schemes. For example, by using a MPPM (24, 3) scheme with eight nonoverlapping, self-synchronizing symbols in a set, the bit rate is increased to three bits per symbol and when paired with an effective rate R=⅓ turbo encoder, the method can transmit at the baseline one bit per symbol while still achieving coding gain associated with FEC techniques. FIG. 29 shows that implementing an MPPM scheme results in an initial improvement in BER, followed by additional coding gain after implementing FEC. For a BER of 10⁻⁴, this scheme results in a coding gain of 7.2 dB.

In summary, this section presented coding techniques for reducing BER in communication channels, detailed the improvements of symbol detection through the use of CNN prediction values, and presented multi-symbol generation of a nonoverlapping MPPM alphabet as a solution for recovering data rate losses due to FEC. It is shown that wavelet analysis is effective in obtaining correlation coefficients across a range of frequencies to identify pulses which vary in frequency. The disclosed detection method performed comparably to a matched filter, while compensating for pulse timing drift and this variation in pulse frequency. Additionally, when paired with MPPM schemes and FEC coding, a 7.2 dB coding gain is achieved. The following section presents conclusions, including significant contributions and recommendations for future work in this field.

### SECTION 4: CONCLUSIONS

This effort used the variable frequency properties of the CWT to identify pulse signals in a communication channel in noise. Unlike other signal processing techniques, like the matched filter, the CWT performs convolution calculations across a range of frequencies and is effective in identifying pulses of varying shape, locating transient features of the waveform. By normalizing the response across individual frequencies, viable images were able to be created for transfer learning with the GOOGLENET CNN architecture. The method exploits the prediction values associated with CNN classification and the redundant pulses in MPPM modulation for symbol decoding with improved BER.

The disclosed method successfully decoded bit information of a basic experimental signal in noise. Additionally, the disclosed method succeeded in improving results through implementation of FEC and MPPM modulation techniques. After training the CNN, an example embodiment processed an experimental transmission of 108 bits, achieving a 2.78% BER without FEC. Then applied were FEC techniques and an MPPM scheme to a simulation signal comprised of pulses and noise from the experimental signal, achieving 100% FEC capability in noisy environments up to 32 times experimental observation.

The most significant contribution of this disclosure is the use of wavelets to produce images for training a CNN to detect pulses in a communication channel, decoding multiple coding schemes by leveraging the prediction values of the CNN output. Unlike traditional communications receivers, which utilize thresholds derived from statistical features of the communications channel, the disclosed method uses these prediction values from the CNN as the decision variable. Additionally, the use of wavelets allows for a higher detection of pulses with varying frequency than the matched filter. This is especially important when considering the changing nature of many communication channels.

A second significant contribution is the analysis presented on multiple transmitters and the reduction in BER. By transmitting the information bit with multiple transmitters and comparing the detector results, the BER is decreased exponentially without the use of FEC techniques. In the case of a time window of three times the pulse length, the BER is reduced from 0.0224 to 9.62×10⁻⁴. The results increase dramatically with additional transmitters. Four transmitters result in further reduction in BER to 1.94×10⁻⁶.

A third significant contribution is the use of a MPPM scheme with multilevel symbol use. By implementing MPPM (Q, p) schemes with larger alphabets of noninterfering symbols, it is shown that the method can transmit more bits per symbol and recover data rate lost due to FEC. Additionally, the use of CNN estimation values for MPPM decoding results in a significant improvement in BER prior to FEC decoding with high levels of interference noise.

Another significant contribution is the validation of FEC schemes when applied to a noisy communication channel with a MPPM coding structure. By applying a MPPM structure with a larger number of nonoverlapping sequences, the method can transmit more symbols and achieve a higher bit rate. This allows us to recover the reduction in bit rate due to FEC. When transmitting a single bit per pulse, without FEC or implementing an MPPM scheme, the disclosed detection method results in a BER of 5.12% when experiencing low levels of interference noise. By applying a rate R=⅓ turbo encoder and an MPPM scheme with eight nonoverlapping sequences, or three bits per symbol, an effective bit rate of one bit per pulse is maintained but improving the BER to approximately 10⁻³.

The use of low-density parity-check (LDPC) codes with a rates R=½ and ⅘ was explored. When decoding the received message, it was discovered that little gain in accuracy between GOOGLENET results and the FEC decoded message. For this reason, the disclosed example embodiments described herein, describe the use of turbo encoders. In many applications with large data transmissions, LDPC codes perform extremely well and can be considered for future simulations.

In noisy environments with a significant number of interference pulses, MPPM (Q, p) schemes with fewer symbols in a set contain fewer timeslots in which a pulse may be transmitted. Additionally, these time slots are distinguishable across the alphabet, allowing the prediction values of the CNN to further improve BER in noise. Smart selection of MPPM (Q, p) schemes based on the interference pulse arrival rate should be investigated for implementation.

Finally, the disclosed method utilized a pretrained CNN architecture to reduce training time and allow for high levels of accuracy on minimal training data. Many other neural network architectures show promise for detecting symbols in communication data including recurrent neural networks [Ref. 6]. Other networks should be implemented and compared for further implementation. Additionally, directly inputting coefficient values into the CNN may produce similar results to those identified in this work and may contribute to increasing processing speed of the detector.

### REFERENCES

[Ref. 1] M. Hamilton, R. Sengupta and R. Astala, “Saving snow leopards with deep learning and computer vision on spark,” Microsoft Corporation, 27 Jun. 2017.
[Ref. 2] ] G. Bortolan, I. Christov and I. Simova, “Rule-based method and deep learning networks for automatic classification of ECG,” 2020 Computing in Cardiology, pp. 1-4, 2020.
[Ref. 3] R. Saini, N. Bindal and P. Bansal, “Classification of heart diseases from ECG signals using wavelet transform and kNN classifier,” International Conference on Computing, Communication & Automation, pp. 1208-1215, 2015.
[Ref. 4] E. Yilmaz and M. Trocan, “A modified version of GoogLeNet for melanoma diagnosis,” Journal of information and telecommunication (Print), vol. 5, no. 3, pp. 395-405, 2021.
[Ref. 5] D. Garg and G. K. Verma, “Emotion recognition in valence-arousal space from multichannel EEG data and wavelet based deep learning framework,” Procedia Computer Science, vol. 171, pp. 857-867, 2020.
[Ref. 6] N. Farsad and A. Goldsmith, “Neural network detection of data sequences in communication systems,” IEEE transactions on signal processing, vol. 66, no. 21, p. 5663-5678, 2018.
[Ref. 7] N. Shlezinger, N. Farsad, Y. C. Eldar and A. J. Goldsmith, “ViterbiNet: a deep learning based viterbi algorithm for symbol detection,” IEEE transactions on wireless communications, vol. 19, no. 5, p. 3319-3331, 2020.
[Ref. 8] W. Jang and W. Lee, “Detecting wireless steganography with wavelet analysis,” IEEE wireless communications letters, vol. 10, no. 2, p. 383-386, 2021.
[Ref. 9] K. Wirsing, “Time frequency analysis of wavelet and fourier transform,” in Wavelet Theory.
[Ref. 10] A. Pradana, N. Ahmadi, T. Adiono, W. A. Cahyadi and Y. Chung, “VLC physical layer design based on pulse position modulation (PPM) for stable illumination,” in 2015 International Symposium on Intelligent Signal Processing and Communication Systems (ISPACS), 2015.
[Ref. 11] S. Koss, “Symbol generation and frame synchronization for multipulse pulse position modulation,” M.S. thesis Dept of Electrical and Computer Engineering, NPS, Monterey, CA, USA, 2020.
[Ref. 12] A. G. Bell, Letter from Alexander Graham Bell to Alexander Melville Bell, District of Columbia: Library of Congress, 1880.
[Ref. 13] I. Lu, C. Yeh, D. Hsu and C. Chow, “Utilization of 1-GHz VCSEL for 11.1-Gbps OFDM VLC wireless communication,” IEEE Photonics Journal, vol. 8, no. 3, pp. 1-6, 2016.
[Ref.14] A. M. Zaiton, C. H. Eng and F. Jasman, “Pulse position modulation characterization for indoor visible light communication system,” J. Phys.: Conf., vol. Ser. 1502, no. 012005, 2020.
[Ref. 15] T. Komine and M. Nakagawa, “Fundamental analysis for visible-light communication system using LED lights,” IEEE transactions on consumer electronics, vol. 50, no. 1, pp. 100-107, 2004.
[Ref. 16] S. Zhao, “A serial concatenation-based coding scheme for dimmable visible light communication systems,” IEEE communications letters, vol. 20, no. 10, pp. 1951-1954, 2016.
[Ref. 17] H. S. a. K. Nosu, “MPPM: a method for improving the band-utilization efficiency in optical PPM,” J. Lightwave Technol, Vols. LT-7, no. 3, pp. 465-472, Mar. 1989.
[Ref. 18] R. Velidi and C. N. Georghiades, “Frame synchronization for optical multi-pulse pulse position modulation,” IEEE Transactions on Communications, vol. 43, no. 2/3/4, pp. 1838-1843, 1995.
[Ref. 19] S. Koss, C. McAbee, M. Tummala and J. McEachen, “Symbol generation and frame synchronization for multipulse-pulse position modulation over optical channels,” 14th International Conference on Signal Processing and Communication, December 2020.
[Ref. 20] X. Xu, C. Wang, Y. Zhu, X. Ma and X. Zhang, “Block Markov superposition transmission of short codes for indoor visible light communications,” IEEE communications letters, vol. 19, no. 3, p. 359-362, 2015.
[Ref. 21] S. Lin and D. J. Costello, Error Control Coding: Fundamentals and Applications, 2nd ed, Upper Saddle River, N.J: Pearson-Prentice Hall, 2004.
[Ref. 22] S. H. Lee and J. K. Kwon, “Turbo code-based error correction scheme for dimmable visible light communication systems,” IEEE photonics technology letters, vol. 24, no. 17, pp. 1463-1465, 2012.
[Ref. 23] J. Kim and H. Park, “A coding scheme for visible light communication with wide dimming range,” IEEE photonics technology letters, vol. 26, no. 5, pp. 465-468, 2014.
[Ref. 24] D. Gabor, “Theory of communication. Part 3: Frequency compression and expansion,” Electrical Engineers—Part III: Radio and Communications, Journal of the Institution of, vol. 93, no. 26, pp. 445-457, 1946.
[Ref. 25] I. Daubechies, Ten Lectures on Wavelets, Philadelphia: SIAM Press, 1992.
[Ref. 26] P. Kim, MATLAB Deep Learning: with Machine Learning, Neural Networks and Artificial Intelligence, New York, NY: Apress, 2017.
[Ref. 27] Y. LeCun and et al., “Backpropagation applied to handwritten zip code recognition,” Neural computation, vol. 1, no. 4, pp. 541-551, 1989. [Ref. 28]
[Ref. 28] Y. Lecun, L. Bottou, Y. Bengio and P. Haffner, “Gradient-based learning applied to document recognition,” Proceedings of the IEEE, vol. 86, no. 11, p. 2278-2324, 1998.
[Ref. 29] Mathworks, “Classify time series using wavelet analysis and deep learning,” MATLAB,
[Ref. 30] C. Szegedy et al., “Going deeper with convolutions,” 2015 IEEE Conference on Computer Vision and Pattern Recognition (CVPR), pp. 1-9, 2015.
[Ref. 31] D. Chicco and G. Jurman, “The advantages of the Matthews correlation coefficient (MCC) over F1 score and accuracy in binary classification evaluation,” BMC genomics, vol. 21, no. 1, p. 6, 2020.
[Ref. 32] M. Sokolova, N. Japkowicz and S. Szpakowicz, “Beyond accuracy, F-score and ROC: a family of discriminant measures for performance evaluation,” Proceedings of Advances in Artificial Intelligence (AI 2006), Lecture Notes in Computer Science, vol. 4304, pp. 1015-1021, 2006.
[Ref. 33] Q. Gu, L. Zhu and Z. Cai, “Evaluation measures of the classification performance of imbalanced data sets,” Proceedings of ISICA 2009—the 4th International Symposium on Computational Intelligence and Intelligent Systems, Communications in Computer and Information Science, vol. 51, pp. 461-471, 2009.
[Ref. 34] C. W. Therrien and M. Tummala, Probability and Random Processes for Electrical and Computer Engineers 2nd ed, Baton Rouge: CRC Press LLC, 2012.
[Ref. 35] K. Larsen, “Short convolutional codes with maximal free distance for rates ½, ⅓, and ¼ (Corresp.),” IEEE transactions on information theory, vol. 19, no. 3, pp. 371-372, 1973.
[Ref. 36] T. K. Moon, Error Correction Coding: Mathematical Methods and Algorithms, Honoken, N.J., Wiley-Interscience, 2005.

### APPENDIX MATLAB CODE

This appendix includes the MATLAB code developed for implementing a deep learning approach to detecting pulses in noise, applying FEC functions, and generating MPPM sequences, according to an example embodiment of this disclosure.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A method for detecting pulsed communication signals, the method comprising:
processing a received training data signal, which includes a noise element, with a continuous wavelet transformation (CWT) process to obtain a time-frequency representation of the received training data signal, the received training data signal representative of a known/training bitstream associated with a transmitted pulse signal;
using a scalogram process to convert the time-frequency representation of the received training data signal into a plurality of training images, each training image associated with a single bit of information which includes either a high bit state or a low bit state;
training a deep learning architecture platform with the plurality of training images to generate a classification model representative of a plurality of high bit states and a plurality of low bit states included in the plurality of training images;
receiving an incoming target data signal, the incoming signal including a data bitstream represented as a series of pulses and the incoming signal also including one or more noise elements, using the CWT process to obtain a time-frequency representation of the received incoming data signal, and using the scalogram process to convert the time-frequency representation of the received incoming target data signal into a plurality of respective target images representative of each of the bit states in the incoming target data signal bitstream; and
using the trained deep learning architecture platform, classifying each of the plurality of respective target images as one of a high bit state and a low bit state; and
generating an output bitstream based on the plurality of respective target images associated with the incoming data signal,
wherein the incoming target data signal is one or both of turbo encoded and multipulse pulse position modulation (MPPM) encoded.

2. The method of claim 1, wherein coefficients of the CWT are obtained by convolving the training and/or target received data signal with the CWT at various frequencies according to:
$$f = \{ \frac{{f}_{c}}{{NT}_{s}} : n ∈ {ℤ}^{+} \}$$
wherein f_{c} is a wavelet center frequency, Tₛ is a sampling period, and N is a scaling integer.

3. The method of claim 1, wherein the time-frequency representation is a matrix of coefficients, each row of the matrix signifying a wavelet frequency used to convolute the received signal, and each column of the matrix signifying a time of receipt of the received data signal.

4. The method of claim 3, wherein each row of the matrix is individually normalized before the matrix is converted to the plurality of training images or the plurality of target images.

5. The method of claim 1, wherein a color axis of a generated scalogram is scaled by setting an upper threshold and a lower threshold to reduce ambient noise captured during the CWT processing.

6. The method of claim 5, wherein the upper threshold and lower threshold are determined based on probabilistic identities of a histogram of all coefficients.

7. The method of claim 1, wherein one or both of the training data signals and target data signals have a predetermined preamble including a predetermined bitstream.

8. The method of claim 7, wherein the predetermined preamble includes MPPM encoded data, and the MPPM data is used by a received to perform a self-synchronization process.

9. The method of claim 1, wherein using the scalogram process to convert the time-frequency representation of the received signal into a plurality of respective target images representative of each of the bits in the bitstream includes a bit window 3 times the length an associated pulse period.

10. A method for decoding multipulse pulse position modulation (MPPM) symbols included in a received data signal, the method comprising:
receiving an incoming target data signal, the incoming signal including a data bitstream represented as a series of pulses based on an MPPM symbol representative of a series of time slots where a pulse may or may not occur, and the incoming target data signal also including one or more noise elements,
using the continuous wavelet transformation (CWT) process to obtain a time-frequency representation of the received incoming data signal;
using a scalogram process to convert the time-frequency representation of the received training data signal into a plurality of training images, each training image associated with a single bit of information which includes either a high bit state or a low bit state; and
using a trained deep learning architecture platform to assign probabilities in a decision matrix, the probabilities associated with the likelihood that a 1 or 0 bit was transmitted for specific time slots associated with the MPPM symbol,
determining a location of the highest probability that a 1 bit (high) was received;
comparing the location of a received bit with the highest probability to possible sequences to identify a matching bit sequence associated with a predetermined set of possible bit sequences to identify a matching bit sequence; and
decoding the symbol based on the matching bit sequence.

11. The method of claim 10, the method further comprising:
inputting a length, l, of a transmitted symbol; and
building a table of length l containing the assigned probabilities.

12. A system for detecting pulsed communication signals, the system comprising:
a data signal receiver processing a received training data signal, which includes a noise element, with a continuous wavelet transformation (CWT) process to obtain a time-frequency representation of the received training data signal, the received training data signal representative of a known/training bitstream associated with a transmitted pulse signal;
a scalogram module converting the time-frequency representation of the received training data signal into a plurality of training images, each training image associated with a single bit of information which includes either a high bit state or a low bit state;
a deep learning architecture platform operatively associated with the scalogram module, training the deep learning architecture platform with the plurality of training images to generate a classification model representative of a plurality of high bit states and a plurality of low bit states included in the plurality of training images; and the system for detecting pulse signals performing the method comprising:
receiving an incoming target data signal, the incoming signal including a data bitstream represented as a series of pulses and the incoming signal also including one or more noise elements, using the CWT process to obtain a time-frequency representation of the received incoming data signal, and using the scalogram process to convert the time-frequency representation of the received incoming target data signal into a plurality of respective target images representative of each of the bit states in the incoming target data signal bitstream;
using the trained deep learning architecture platform, classifying each of the plurality of respective target images as one of a high bit state and a low bit state, and
generating an output bitstream based on the plurality of respective target images associated with the incoming data signal,
wherein the incoming target data signal is one or both of turbo encoded and multipulse pulse position modulation (MPPM) encoded.

13. The system of claim 12, wherein coefficients of the CWT are obtained by convolving the training and/or target received data signal with the CWT at various frequencies according to:
$$f = \{ \frac{{f}_{c}}{{NT}_{s}} : n ∈ {ℤ}^{+} \}$$
wherein f_{c} is a wavelet center frequency, Tₛ is a sampling period, and N is a scaling integer.

14. The system of claim 12, wherein the time-frequency representation is a matrix of coefficients, each row of the matrix signifying a wavelet frequency used to convolute the received signal, and each column of the matrix signifying a time of receipt of the received data signal.

15. The system of claim 14, wherein each row of the matrix is individually normalized before the matrix is converted to the plurality of training images or the plurality of target images.

16. The system of claim 12, wherein a color axis of a generated scalogram is scaled by setting an upper threshold and a lower threshold to reduce ambient noise captured during the CWT processing.

17. The system of claim 16, wherein the upper threshold and lower threshold are determined based on probabilistic identities of a histogram of all coefficients.

18. The system of claim 12, wherein one or both of the training data signals and target data signals have a predetermined preamble including a predetermined bitstream.

19. The system of claim 18, wherein the predetermined preamble includes MPPM encoded data, and the MPPM data is used by a received to perform a self-synchronization process.

20. The system of claim 12, wherein using the scalogram process to convert the time-frequency representation of the received signal into a plurality of respective target images representative of each of the bits in the bitstream includes a bit window 3 times the length an associated pulse period.
